(19) United States
(12) Patent Application Publication
(10) Pub. No.: US 2026/0040309 A1
(43) Pub. Date: Feb. 5, 2026

(54) TRANSMISSION RECEPTION POINT MODE SWITCHING

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 19/099,898

(22) PCT Filed: Sep. 30, 2022
(86) PCT No.: PCT/CN2022/123060

§ 371 Date: Jan. 30, 2025

(51) Int. Cl. H04W 72/20; H04L 5/00; H04W 72/12

(52) U.S. Cl. CPC H04W 72/20; H04L 5/001; H04W 72/12

(57) ABSTRACT

Methods, systems, and devices for wireless communications are described. A user equipment (UE) may receive a first control message including a first transmission configuration indicator (TCI) codepoint. The first TCI codepoint may indicate multiple unified TCI states for wireless communication at the UE using a communication channel. In response to receiving the first control message, the UE may communicate a first message using the communication channel, The UE may communicate the first message in accordance with the multiple transmission reception point (mTRP) operation mode based on the first TCI codepoint indicating the multiple unified TCI states.

### CROSS REFERENCE

The present Application is a 371 national phase filing of International PCT Application No. PCT/CN2022/123060 by YUAN et al., entitled “TRANSMISSION RECEPTION POINT MODE SWITCHING,” filed Sep. 30, 2022, which is assigned to the assignee hereof, and which is expressly incorporated by reference in its entirety herein.

### FIELD OF TECHNOLOGY

The following relates to wireless communications, including transmission reception point (TRP) mode switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Some wireless communications systems may support wireless communications with multiple transmission reception points (TRPs).

### SUMMARY

The described techniques relate to improved methods, systems, devices, and apparatuses that support transmission reception point (TRP) mode switching. For example, the described techniques provide a framework for switching between a single TRP (sTRP) operation mode and a multiple TRP (mTRP) operation mode using a transmission configuration indicator (TCI) codepoint. In some examples, a user equipment (UE) may receive a first control message including a first TCI codepoint. The first TCI codepoint may indicate multiple unified TCI states for wireless communication at the UE using a communication channel. In some examples, in response to receiving the first control message, the UE may communicate a first message using the communication channel. For example, the UE may communicate the first message in accordance with the mTRP operation mode based on the first TCI codepoint indicating the multiple unified TCI states.

A method for wireless communication at a UE is described. The method may include receiving a first control message including a first TCI codepoint that indicates a set of multiple unified TCI states for wireless communications at the UE using a communication channel and communicating a first message using the communication channel in accordance with a mTRP operation mode based on the first TCI codepoint indicating the set of multiple unified TCI states.

An apparatus for wireless communication is described. The apparatus may include a memory, a transceiver, and at least one processor of a UE, the at least one processor coupled with the memory and the transceiver. The at least one processor may be configured to receive a first control message including a first TCI codepoint that indicates a set of multiple unified TCI states for wireless communications at the UE using a communication channel and communicate a first message using the communication channel in accordance with a mTRP operation mode based on the first TCI codepoint indicating the set of multiple unified TCI states.

Another apparatus for wireless communication is described. The apparatus may include means for receiving a first control message including a first TCI codepoint that indicates a set of multiple unified TCI states for wireless communications at the UE using a communication channel and means for communicating a first message using the communication channel in accordance with a mTRP operation mode based on the first TCI codepoint indicating the set of multiple unified TCI states.

A non-transitory computer-readable medium storing code for wireless communication at a UE is described. The code may include instructions executable by a processor to receive a first control message including a first TCI codepoint that indicates a set of multiple unified TCI states for wireless communications at the UE using a communication channel and communicate a first message using the communication channel in accordance with a mTRP operation mode based on the first TCI codepoint indicating the set of multiple unified TCI states.

Some examples of the method, apparatuses, and non-transitory computer-readable medium described herein may further include operations, features, means, or instructions for receiving a second control message including a second TCI codepoint that indicates a unified TCI state of the set of multiple unified TCI states and schedules a resource for communicating a second message using the communication channel and communicating the second message using the resource for communicating the second message and the unified TCI state in accordance with a sTRP operation mode based on the second TCI codepoint indicating the unified TCI state.

Some examples of the method, apparatuses, and non-transitory computer-readable medium described herein may further include operations, features, means, or instructions for communicating a third message subsequent to the second message, the third message communicated using the communication channel in accordance with the mTRP operation mode.

Some examples of the method, apparatuses, and non-transitory computer-readable medium described herein may further include operations, features, means, or instructions for receiving a third control message scheduling a resource for communicating a third message using a second communication channel and communicating the third message using the resource for communicating the third message and the unified TCI state in accordance with the sTRP operation mode based on the communication channel being associated with a same component carrier or a same set of component carriers as the second communication channel.

Some examples of the method, apparatuses, and non-transitory computer-readable medium described herein may further include operations, features, means, or instructions for receiving a second control message indicating a set of associated channel types that includes at least a first channel type associated with the communication channel and a second channel type associated with a second communication channel and communicating a second message using the second communication channel in accordance with the mTRP operation mode based on the first channel type being associated with the second channel type.

In some examples of the method, apparatuses, and non-transitory computer-readable medium described herein, the first channel type includes one of a physical downlink control channel (PDCCH), a physical downlink shared channel (PDSCH), a physical uplink control channel (PUCCH), and a physical uplink shared channel (PUSCH) and the second channel type includes another of the PDCCH, the PDSCH, the PUCCH, and the PUSCH.

Some examples of the method, apparatuses, and non-transitory computer-readable medium described herein may further include operations, features, means, or instructions for receiving a second control message scheduling a set of multiple resources for transmission of a second message using a second communication channel and transmitting the second message using the set of multiple resources and the set of multiple unified TCI states in accordance with a sTRP operation mode and a mapping between the set of multiple resources and the set of multiple unified TCI states.

Some examples of the method, apparatuses, and non-transitory computer-readable medium described herein may further include operations, features, means, or instructions for receiving a second control message indicating a configuration for unified TCI state selection for wireless communications at the UE using a second communication channel, receiving a third control message scheduling a set of multiple resources for transmission of a second message using the second communication channel, and transmitting the second message using the set of multiple resources and a unified TCI state in accordance with a sTRP operation mode, where the unified TCI state may be selected at the UE from the set of multiple unified TCI states in accordance with the configuration.

Some examples of the method, apparatuses, and non-transitory computer-readable medium described herein may further include operations, features, means, or instructions for receiving a second control message scheduling a first resource for transmission of a second message using a second communication channel, transmitting the second message using the first resource and a first unified TCI state of the set of multiple unified TCI states in accordance with a sTRP operation mode, and transmitting the second message using a second resource and a second unified TCI state of the set of multiple unified TCI states in accordance with the sTRP operation mode.

Some examples of the method, apparatuses, and non-transitory computer-readable medium described herein may further include operations, features, means, or instructions for receiving a second control message indicating a configuration for unified TCI state selection for wireless communications at the UE using a second communication channel, receiving a third control message scheduling a resource for transmission of a second message using the second communication channel, and transmitting the second message using the resource for transmission of the second message and a unified TCI state in accordance with a sTRP operation mode, the unified TCI state selected at the UE in accordance with the configuration.

A method for wireless communication at a network entity is described. The method may include outputting a first control message including a first TCI codepoint that indicates a set of multiple unified TCI states for wireless communications at a UE using a communication channel, the set of multiple unified TCI states indicating, to the UE, to communicate using the communication channel in accordance with a mTRP operation mode and communicating a first message with the UE using the communication channel based on the network entity being associated with a unified TCI state of the set of multiple unified TCI states.

An apparatus for wireless communication is described. The apparatus may include a memory and at least one processor of a network entity, the at least one processor coupled with the memory. The at least one processor may be configured to output a first control message including a first TCI codepoint that indicates a set of multiple unified TCI states for wireless communications at a UE using a communication channel, the set of multiple unified TCI states indicating, to the UE, to communicate using the communication channel in accordance with a mTRP operation mode and communicate a first message with the UE using the communication channel based on the network entity being associated with a unified TCI state of the set of multiple unified TCI states.

Another apparatus for wireless communication is described. The apparatus may include means for outputting a first control message including a first TCI codepoint that indicates a set of multiple unified TCI states for wireless communications at a UE using a communication channel, the set of multiple unified TCI states indicating, to the UE, to communicate using the communication channel in accordance with a mTRP operation mode and means for communicating a first message with the UE using the communication channel based on the network entity being associated with a unified TCI state of the set of multiple unified TCI states.

A non-transitory computer-readable medium storing code for wireless communication at a network entity is described. The code may include instructions executable by a processor to output a first control message including a first TCI codepoint that indicates a set of multiple unified TCI states for wireless communications at a UE using a communication channel, the set of multiple unified TCI states indicating, to the UE, to communicate using the communication channel in accordance with a mTRP operation mode and communicate a first message with the UE using the communication channel based on the network entity being associated with a unified TCI state of the set of multiple unified TCI states.

Some examples of the method, apparatuses, and non-transitory computer-readable medium described herein may further include operations, features, means, or instructions for outputting a second control message including a second TCI codepoint that indicates the unified TCI state of the set of multiple unified TCI states and schedules a resource for communicating a second message using the communication channel, the unified TCI state indicating, to the UE, to communicate using the communication channel in accordance with a sTRP operation mode and communicating the second message using the resource for communicating the second message based on the second TCI codepoint indicating the unified TCI state associated with the network entity.

Some examples of the method, apparatuses, and non-transitory computer-readable medium described herein may further include operations, features, means, or instructions for outputting a third control message scheduling a resource for communicating a third message using a second communication channel and communicating the third message using the resource for communicating the third message based on the communication channel being associated with a same component carrier or a same set of component carriers as the second communication channel.

Some examples of the method, apparatuses, and non-transitory computer-readable medium described herein may further include operations, features, means, or instructions for outputting a second control message indicating a set of associated channel types that includes at least a first channel type associated with the communication channel and a second channel type associated with a second communication channel and communicating a second message using the second communication channel based on the first channel type being associated with the second channel type.

In some examples of the method, apparatuses, and non-transitory computer-readable medium described herein, the first channel type includes one of a PDCCH, a PDSCH, a PUCCH, and a PUSCH and the second channel type includes another of the PDCCH, the PDSCH, the PUCCH, and the PUSCH.

Some examples of the method, apparatuses, and non-transitory computer-readable medium described herein may further include operations, features, means, or instructions for outputting a second control message scheduling, at the UE, a set of multiple resources for communicating a second message using a second communication channel and obtaining, from the UE, the second message using a resource of the set of multiple resources based on a mapping between the set of multiple resources and the set of multiple unified TCI states.

Some examples of the method, apparatuses, and non-transitory computer-readable medium described herein may further include operations, features, means, or instructions for outputting a second control message indicating a configuration for unified TCI state selection, at the UE, for wireless communications using a second communication channel, outputting a third control message scheduling, at the UE, a set of multiple resources for communicating a second message using the second communication channel, and obtaining, from the UE, the second message using the set of multiple resources based on the UE selecting the unified TCI state from the set of multiple unified TCI states in accordance with the configuration.

Some examples of the method, apparatuses, and non-transitory computer-readable medium described herein may further include operations, features, means, or instructions for outputting a second control message indicating a configuration for unified TCI state selection, at the UE, for wireless communications using a second communication channel, outputting a third control message scheduling, at the UE, a resource for communicating a second message using the second communication channel, and obtaining, from the UE, the second message using the resource for communicating the second message based on the UE selecting the unified TCI state in accordance with the configuration.

### BRIEF DESCRIPTION OF THE DRAWINGS

FIGS. 1 and 2 each illustrate an example of a wireless communications system that supports transmission reception point (TRP) mode switching in accordance with one or more aspects of the present disclosure.

FIG. 3 illustrates an example of a timing diagram that supports TRP mode switching in accordance with one or more aspects of the present disclosure.

FIG. 4 illustrates an example of a process flow that supports TRP mode switching in accordance with one or more aspects of the present disclosure.

FIGS. 5 and 6 show block diagrams of devices that support TRP mode switching in accordance with one or more aspects of the present disclosure.

FIG. 7 shows a block diagram of a communications manager that supports TRP mode switching in accordance with one or more aspects of the present disclosure.

FIG. 8 shows a diagram of a system including a device that supports TRP mode switching in accordance with one or more aspects of the present disclosure.

FIGS. 9 and 10 show block diagrams of devices that support TRP mode switching in accordance with one or more aspects of the present disclosure.

FIG. 11 shows a block diagram of a communications manager that supports TRP mode switching in accordance with one or more aspects of the present disclosure.

FIG. 12 shows a diagram of a system including a device that supports TRP mode switching in accordance with one or more aspects of the present disclosure.

FIGS. 13 through 16 show flowcharts illustrating methods that support TRP mode switching in accordance with one or more aspects of the present disclosure.

### DETAILED DESCRIPTION

Some wireless communications systems may include a communication device, such as a user equipment (UE), that support wireless communications with one transmission reception point (TRP) or multiple TRPs. For example, a communication network, such as one or more network entities, may configure the UE to operate in a single TRP (sTRP) operation mode in which the UE may communicate with a single TRP (e.g., a single network entity) using a single beam. Additionally, or alternatively, the communication network may configure the UE to operate in a multiple TRP (mTRP) operation mode in which the UE may communicate with multiple (e.g., different) TRPs concurrently, for example using multiple (e.g., different) beams. In some examples, the UE may identify a beam to use for communications with the communication network based on a unified transmission configuration indicator (TCI) state.

As described herein, a unified TCI state may refer to a TCI state that identifies a beam which may be common to multiple channels or multiple reference signals. For example, a unified TCI state may identify a beam that may be common to more than one downlink channel, uplink channel, or reference signal. In some examples, a TRP may be associated with a respective unified TCI state. For example, the UE may identify a beam to use for communications with a TRP (e.g., in accordance with the sTRP operation mode or the mTRP operation mode) based on a unified TCI state associated with the TRP. The unified TCI state may be indicated to (or otherwise configured at) the UE. For example, the communication network may indicate a single unified TCI state to the UE to configure the UE to operate in the sTRP operation mode. Additionally, or alternatively, the communication network may indicate multiple unified TCI states to the UE to configure the UE to operate in the mTRP operation mode. In some examples, however, the communication network may be incapable of configuring the UE to dynamically switch between the sTRP operation mode and the mTRP operation mode.

Various aspects of the present disclosure generally relate to techniques for TRP mode switching, and more specifically, to a framework for configuring a UE to dynamically switch between an sTRP operation mode and an mTRP operation mode using a TCI codepoint. For example, the UE may receive a first control message that includes a first TCI codepoint. The first TCI codepoint may indicate, to the UE, multiple unified TCI states. For example, the first TCI codepoint may indicate a first unified TCI state and a second unified TCI state. In such an example, the first TCI codepoint may configure the UE to communicate in accordance with the mTRP operation mode. Additionally, or alternatively, the UE may receive a second control message that includes a second TCI codepoint. The second TCI codepoint may indicate, to the UE, a single unified TCI state. For example, the second TCI codepoint may indicate the first unified TCI state. Additionally, or alternatively, the second control message may schedule resources for the UE to communicate a message. In such an example, in response to receiving the second control message, the UE may determine to communicate the message in accordance with the sTRP operation mode. For example, the UE may use the first unified TCI state in accordance with the sTRP operation mode to communicate the message with a TRP (e.g., network entity) associated with the first unified TCI state. In some examples, subsequent to communicating the message, the UE may switch to the mTRP operation mode, for example to communicate subsequent messages with the TRP associated with the first unified TCI state and another TRP associated with the second unified TCI state.

In some examples, the UE may switch between the sTRP operation mode and the mTRP operation mode for communications using a single communication channel or multiple communication channels. For example, the UE may use the mTRP operation mode to communicate with the communication network using a first type of communication channel and switch to the sTRP operation mode to communicate with the communication network using the first type of communication channel or a second type of communication channel. In some examples, the communication network may configure the UE (or the UE may be otherwise configured) with one or more rules for identifying a unified TCI state to use for uplink communications in accordance with the sTRP operation mode, for example if the UE is configured with multiple unified TCI states to use for downlink communications.

Particular aspects of the subject matter described herein may be implemented to realize one or more potential advantages. For example, some techniques employed at the described communication devices may provide benefits and enhancements to the operation of the communication devices, including enabling a UE to dynamically switch between an sTRP operation mode and an mTRP operation mode. Further, techniques for TRP mode switching, as described herein, may support higher data rates, spectrum efficiency enhancement, and efficient resource utilization, thereby improving throughput and reliability. Such techniques may lead to improved network operations and network work efficiencies, among other possible benefits.

Aspects of the disclosure are initially described in the context of wireless communications systems. Aspects of the disclosure are also described in the context of a timing diagram and a process flow. Aspects of the disclosure are further illustrated by and described with reference to apparatus diagrams, system diagrams, and flowcharts that relate to TRP mode switching.

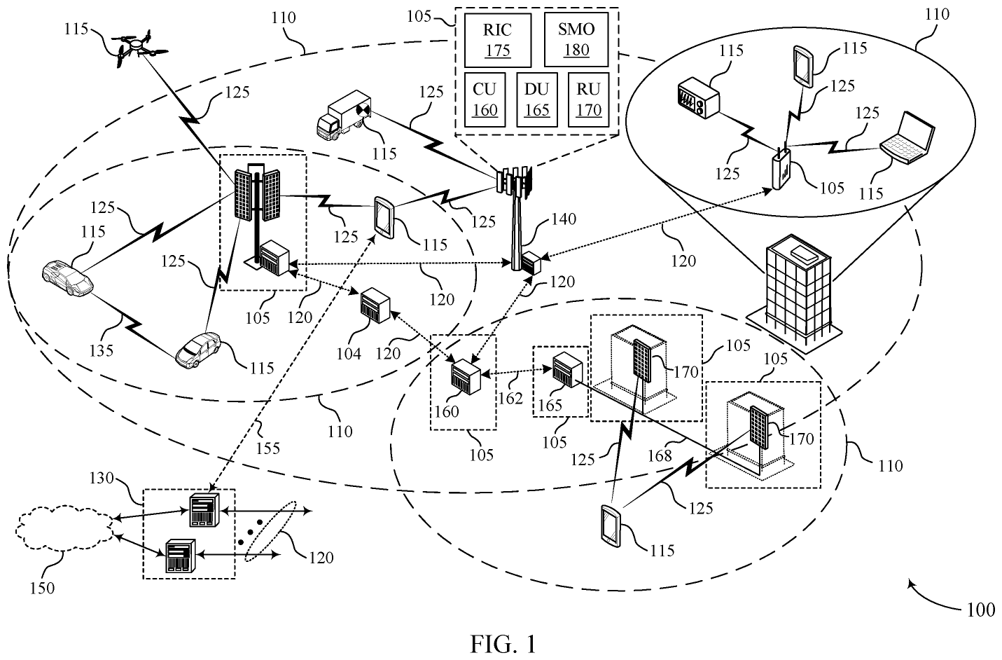

FIG. 1 illustrates an example of a wireless communications system 100 that supports TRP mode switching in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support TRP mode switching as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ˜N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, the wireless communications system 100 may support a framework for switching between an sTRP operation mode and an mTRP operation mode using a TCI codepoint. For example, a UE 115 may receive (e.g., from a network entity 105) a first control message including a first TCI codepoint. The first TCI codepoint may indicate multiple unified TCI states for wireless communication at the UE 115 using a communication channel. In some examples, in response to receiving the first control message, the UE 115 may communicate a first message using the communication channel. For example, the UE 115 may communicate the first message in accordance with the mTRP operation mode based on the first TCI codepoint indicating the multiple unified TCI states. In some examples, using a TCI codepoint to indicate multiple unified TCI states for wireless communication at the UE 115 may lead to increased data rates and efficient resource utilization within the wireless communications system 100, among other possible benefits.

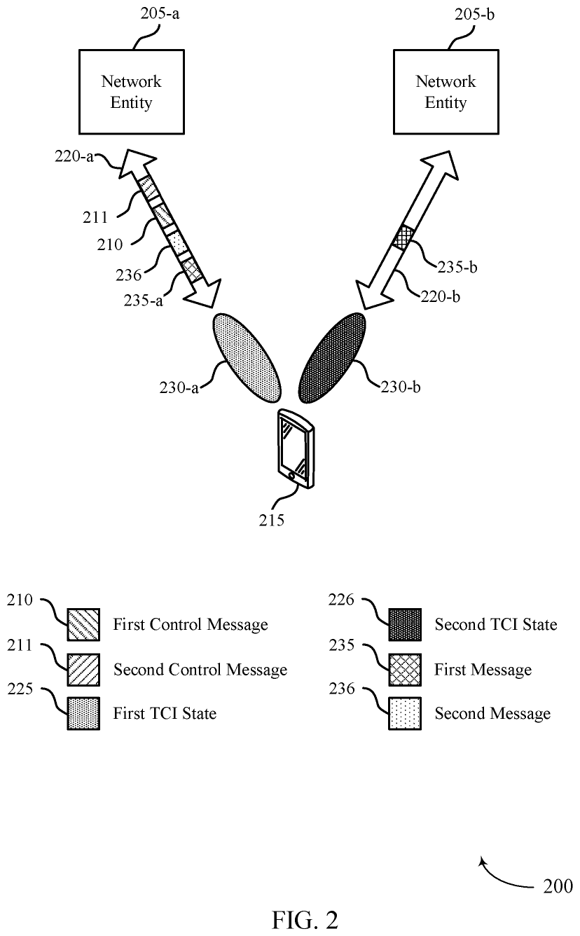

FIG. 2 illustrates an example of a wireless communications system 200 that supports TRP mode switching in accordance with one or more aspects of the present disclosure. In some examples, the wireless communications system 200 may implement or be implemented at one or more aspects of the wireless communications system 100. For example, the wireless communications system 200 may include a UE 215, which may each be an example of a UE 115 described with reference to FIG. 1. The wireless communications system 200 may also include one or more network entities 205 (e.g., a network entity 205-a and a network entity 205-b), which may examples of one or more network entities 105 (e.g., a CU, a DU, an RU, a base station, an IAB node, a TRP, or one or more other network nodes) as described with reference to FIG. 1. In the example of FIG. 2, the UE 215 may communicate with the network entity 205-a using a communication link 220-a and may communicate with the network entity 205-b using a communication link 220-b. In some examples, the communication links 220 may be examples of a communication link 125 as described with reference to FIG. 1.

In some examples of the wireless communications system 200, the UE 215 may support wireless communications using an sTRP operation mode in which the UE may communicate with a single TRP using a single beam. For example, in accordance with the sTRP operation mode, the UE 215 may communicate with the network entity 205-a using a beam 230-a or the UE 215 may communicate with the network entity 205-b using a beam 230-b. Additionally, or alternatively, the UE 215 may support wireless communications using an mTRP operation mode in which the UE 215 may communicate with multiple TRPs concurrently (or simultaneously) using multiple beams. For example, in accordance with the mTRP operation mode, the UE 215 may concurrently communicate with the network entity 205-a using the beam 230-a and the network entity 205-b using the beam 230-b.

In some examples, the wireless communications system 200 may support a unified TCI framework, which may be extended for mTRP operation. For example, the UE 215 may receive (e.g., from the network entity 205-a or the network entity 205-b) an indication of a single unified TCI state, such as one of the first TCI state 225 or the second TCI state 226. In such an example, the UE 215 may determine to communicate with the network entity 205-a or the network entity 205-b (e.g., using the beam 230-a or the beam 230-b, respectively) based on the indicated unified TCI state. For example, the UE 215 may determine to communicate with the network entity 205-a using the beam 230-a based on receiving an indication of the first TCI state 225. In such an example, based on receiving the indication of the single unified TCI state (e.g., the first TCI state) the UE 215 may determine to communicate with the network entity 205-a in accordance with the sTRP operation mode. Additionally, or alternatively, the UE 215 may receive (e.g., from the network entity 205-a or the network entity 205-b) an indication of multiple unified TCI states, such as both the first TCI state 225 and the second TCI state 226. In such an example, the UE 215 may determine to communicate with the network entity 205-a using the beam 230-a and the network entity 205-b using the beam 230-b based on receiving the indication of both the first TCI state 225 and the second TCI state 226, respectively. That is, based on receiving the indication of the multiple unified TCI states the UE 215 may determine to concurrently communicate with the network entity 205-a and the network entity 205-b in accordance with the mTRP operation mode.

In some examples, the network entity 205-a and the network entity 205-b may be incapable of configuring the UE 215 to dynamically switch between the sTRP operation mode and the mTRP operation mode. In some other examples, the wireless communications system 200 may support a unified TCI framework in which switching between sTRP operation and mTRP operation may not be precluded. In such an example, the network entity 205-a, the network entity 205-b, and the UE 215 may support one or more switching options for sTRP operation and mTRP operation in the unified TCI framework. As illustrated in the example of FIG. 2, the UE 215 may receive a first control message 210 from the network entity 205-a. In some examples, the first control message 210 may include a first TCI codepoint that indicates multiple unified TCI states for wireless communications at the UE 215 using a communication channel. In such examples, based on the first TCI codepoint indicating multiple unified TCI states, the UE 215 may communicate (e.g., transmit or receive) a first message 235-a and a first message 235-b using the communication channel in accordance with mTRP operation mode. That is, based on the first TCI codepoint indicating both the first TCI state 225 and the second TCI state 226, the UE 215 may use the mTRP operation mode to concurrently communicate the first message 235-a with the network entity 205-a using the beam 230-a and the first message 235-b with the network entity 205-a using the beam 230-b.

Additionally, or alternatively, the UE 215 may receive a second control message 211 including a second TCI codepoint that indicates a unified TCI state (e.g., of the multiple unified TCI states indicated using the first TCI codepoint). For example, the second control message 211 may indicate the first TCI state 225. Additionally, or alternatively, the second control message 211 may schedule a resource for communicating a second message 236 at the UE 215 using the communication channel (or another communication channel). In such an example, based on the second TCI codepoint indicating the first TCI state 225, the UE 215 may communicate (e.g., transmit or receive) the second message 236 with the network entity 205-a using the resource for communicating the second message 236 and the indicated unified TCI state (e.g., the first TCI state) in accordance with the sTRP operation mode. That is, based on the second TCI codepoint indicating a single unified TCI state, the UE 215 may determine to switch from the mTRP operation mode to the sTRP operation mode for communication of the second message 236. In such examples, the UE 215 may switch from the sTRP operation mode to the mTRP operation mode subsequent to communication of the second message 236. For example, subsequent to communicating the second message 236, the UE 215 may communicate a third message (not shown) with the network entity 205-a and the network entity 205-b in accordance with the mTRP operation mode. In some examples, using a TCI codepoint to enable the UE 215 to dynamically switch between the sTRP operation mode and the mTRP operation mode may lead to improved network operations and network work efficiencies within the wireless communications system 200, among other possible benefits.

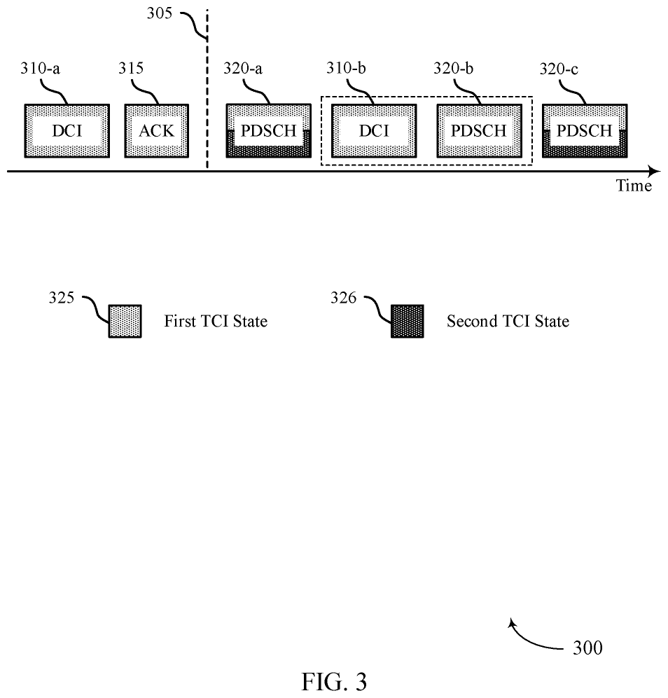

FIG. 3 illustrates an example of a timing diagram 300 that supports TRP mode switching in accordance with one or more aspects of the present disclosure. In some examples, the timing diagram 300 may implement or be implemented at one or more aspects of the wireless communications system 100 and the wireless communications system 200. For example, the timing diagram 300 may be implemented at a UE or a network entity, which may be examples of the corresponding devices as described with reference to FIGS. 1 and 2. For example, the UE may support switching between an sTRP operation mode and an mTRP operation mode in a unified TCI framework.

As illustrated in the example of FIG. 3, the UE may receive a downlink control information (DCI) message 310-a (or, more simply, DCI 310-a), which may correspond to a TCI indication DCI. For example, the DCI 310-a may include a first TCI codepoint that indicates multiple (e.g., different) unified TCI states. In some examples, the first TCI codepoint may indicate multiple unified TCI states using multiple TCI state identifiers (IDs). For example, the first TCI codepoint may indicate a first TCI state 325 using a first TCI state ID (e.g., TCI ID 1) and a second TCI state 326 using a second TCI state ID (e.g., TCI ID 2). In such an example, the first TCI state 325 may be associated with a first TRP (e.g., a first network entity) and the second TCI state 326 may be associated with a second TRP (e.g., a second network entity). In the example of FIG. 3, the first TCI state 325 and the second TCI state 326 may each be an example of a unified TCI state. For example, the first TCI state 325 and the second TCI state 326 may each correspond to a respective beam that may be common to more than one downlink channel, uplink channel, or reference signal. In the example of FIG. 3, the UE may receive the DCI 310-a from the first TRP using the beam corresponding to the first TCI state 325.

In some examples, such as in response to successfully receiving (and decoding) the DCI 310-a, the UE may transmit an acknowledgement (ACK) to the first TRP. For example, the UE may transmit an ACK 315 to the first TRP using the beam corresponding to the first TCI state 325. Additionally, or alternatively, in response to receiving the DCI 310-a, the UE may apply the multiple unified TCI states for a communication channel (e.g., a physical downlink shared channel (PDSCH)) or reference signal (e.g., unless indicated separately). In such an example, the UE may communicate in accordance with the mTRP operation mode using the multiple unified TCI states indicated using the DCI 310-a. For example, the UE may apply the first TCI state 325 and the second TCI state 326 for one or more communications that may occur some duration subsequent to receiving the DCI 310-a. That is, the DCI 310-a may indicate persistent (e.g., static, sticky) mTRP scheduling in which the indicated TCI states may be persistent (e.g., sticky) after an application time 305. For example, subsequent to the application time 305, the UE may receive a PDSCH 320-a from the first TRP using the beam associated with the first TCI state 325 and from the second TRP using a beam associated with the second TCI state 326 in accordance with the mTRP operation mode.

In some other examples, the DCI 310-a may include another TCI codepoint that indicates a single unified TCI state. For example, the other TCI codepoint may indicate a single TCI state ID, such as the first TCI state ID (e.g., TCI ID 1) or the second TCI state ID (e.g., TCI ID 2). In such an example, the UE may apply the single indicated TCI state (e.g., the first TCI state 325 or the second TCI state 326) for the communication channel (e.g., the PDSCH) or the reference signal (e.g., unless indicated separately). For example, the UE may apply the first TCI state 325 or the second TCI state 326 for one or more communications that may occur subsequent to the application time 305. That is, in some other examples, the DCI 310-a may indicate persistent (e.g., sticky) sTRP scheduling in which the indicated TCI state may be persistent (e.g., sticky) after the application time 305.

As illustrated in the example of FIG. 3, the UE may receive the DCI 310-a that may include the first TCI codepoint that indicates multiple unified TCI states, such as the first TCI state ID (e.g., TCI ID 1) and the second TCI state ID (e.g., TCI ID 2). Additionally, or alternatively, the UE may receive a DCI 310-b which may include a second TCI codepoint (e.g., a dynamic codepoint) that indicates a unified TCI state of the multiple unified TCI states indicated using the DCI 310-a. That is, the UE may receive a TCI indication DCI that previously indicates multiple (e.g., different) unified TCI states and subsequently (e.g., later) receive another TCI indication DCI which may include a second TCI codepoint (e.g., a dynamic codepoint, a special codepoint) that may indicate one of the multiple unified TCI states. In such examples, the UE may apply one of the previously indicated multiple unified TCI states for the communication channel (e.g., the PDSCH) or the reference signal. For example, the UE may apply the unified TCI state identified by the second TCI codepoint (e.g., the dynamic codepoint included in the DCI 310-b). In some examples, the second TCI codepoint may indicate multiple same unified TCI states, such as multiple of the first TCI state ID (e.g., the first TCI state ID and the first TCI state ID), to identify the unified TCI state to be used at the UE. Additionally, or alternatively, the second TCI codepoint may indicate for the UE to use a unified TCI state corresponding to a relatively first TCI state ID or a relatively second TCI state ID (or some other suitable TCI state ID) among the multiple TCI states IDs indicated using the first TCI codepoint (e.g., the TCI codepoint included in the DCI 310-a). For example, the second TCI codepoint may indicate for the UE to use a unified TCI state corresponding to a relatively first TCI state ID or a relatively second TCI state ID among multiple TCI state IDs included in a relatively latest received TCI codepoint that indicates multiple unified TCI states (e.g., using the multiple TCI state IDs).

As illustrated in the example of FIG. 3, the UE may receive the DCI 310-a, which includes the first codepoint that indicates the first TCI state ID (e.g., TCI ID 1) corresponding to the first TCI state 325 and the second TCI state ID (e.g., TCI ID 2) corresponding the second TCI state 326. In such an example, the UE may receive the DCI 310-b (e.g., subsequent to receiving the DCI 310-a), which may include the second TCI codepoint (e.g., a dynamic codepoint, a special codepoint) that indicates the first TCI state 325. In such an example, the UE may apply the first TCI state 325 to the communication channel (or reference signal) scheduled by the DCI 310-b (e.g., the DCI indicating the second TCI codepoint). For example, the DCI 310-b may include the second TCI codepoint indicating the first TCI state 325 and may schedule a resource for reception of the PDSCH 320-b at the UE. In such an example, the UE may apply the first TCI state 325 for reception of the PDSCH 320-b. For example, the UE may receive the PDSCH 320-b from the first TRP using the beam associated with the first TCI state 325 in accordance with the sTRP operation mode. That is, the DCI 310-b may indicate dynamic (e.g., one-time, intermittent, not sticky) sTRP scheduling in which the indicated TCI state may be applied to a communication scheduled using the DCI 310-b. For example, subsequent to receiving the PDSCH 320-b in accordance with the sTRP operation mode, the UE may receive a PDSCH 320-c from the first TRP using the beam associated with the first TCI state 325 and from the second TRP using the beam associated with the second TCI state 326 in accordance with the mTRP operation mode. That is, subsequent to receiving the PDSCH 320-b in accordance with the sTRP operation mode, the UE may switch from the sTRP operation mode to (e.g., back to) the mTRP operation mode for reception of the PDSCH 320-c (e.g., and any other subsequent communications).

In some examples, the UE may identify an operation mode associated with a TCI codepoint based on one or more rules or based on a data structure. For example, the UE may identify an operation mode in accordance with the data structure of the following Table 1:

TABLE 1

| TCI Codepoint | |
|---|---|
| Example | Indicated Operation |
| (TCI ID 1, | Persistent mTRP operation |
| TCI ID 2) | |
| TCI ID 1 | Persistent sTRP operation |
| TCI ID 2 | Persistent sTRP operation |
| Dynamic | Dynamic sTRP operation (1^{st} unified TCI state in latest |
| codepoint 0 | indicated TCI codepoint with multiple unified TCI states) |
| Dynamic | Dynamic sTRP operation (2^{nd} unified TCI state in latest |
| codepoint 1 | indicated TCI codepoint with multiple unified TCI states) |

In such an example, the DCI 310-a may include a TCI codepoint that indicates the first TCI state ID and the second TCI state ID (e.g., (TCI ID 1, TCI ID 2)) and the DCI 310-b may include a dynamic codepoint 0. For example, the dynamic codepoint 0 may be used to indicate, to the UE, to use the first TCI state 325 (e.g., corresponding to the first TCI state ID, TCI ID 1) in accordance with dynamic sTRP operations for one or multiple communication channels, such as PDSCH, PUSCH, or PUCCH, that may be scheduled using the DCI 310-b indicating the dynamic codepoint 0. Additionally, or alternatively, the UE may identify an operation mode in accordance with the data structure of the following Table 2:

TABLE 2

| TCI Codepoint | |
|---|---|
| Example | Indicated Operation |
| (TCI ID 1, | Persistent mTRP operation |
| TCI ID 2) | |
| TCI ID 1 | Persistent sTRP operation |
| TCI ID 2 | Persistent sTRP operation |
| Dynamic | Dynamic sTRP operation (1^{st} unified TCI state in latest |
| codepoint 00 | indicated TCI codepoint with multiple unified TCI states) |
| Dynamic | Dynamic sTRP operation (2^{nd} unified TCI state in latest |
| codepoint 01 | indicated TCI codepoint with multiple unified TCI states) |
| Dynamic | Dynamic mTRP operation (with the order of 1^{st} unified |
| codepoint 10 | TCI and 2^{nd} unified TCI in latest indicated TCI codepoint |
| | with multiple unified TCI states) |
| Dynamic | Dynamic mTRP operation (with the order of 2^{nd} unified |
| codepoint 11 | TCI and 1^{st} unified TCI in latest indicated TCI codepoint |
| | with multiple unified TCI states) |

In such an example, the DCI 310-a may include a TCI codepoint that indicates the first TCI state ID and the second TCI state ID (e.g., (TCI ID 1, TCI ID 2)) and the DCI 310-b may include a dynamic codepoint 00. For example, the dynamic codepoint 00 may be used to indicate, to the UE, to use the first TCI state 325 (e.g., corresponding to the first TCI state ID, TCI ID 1) in accordance with dynamic sTRP operations for one or multiple communication channels, such as PDSCH, PUSCH, or PUCCH, that may be scheduled using the DCI 310-b indicating the dynamic codepoint 00. Additionally, or alternatively, the DCI 310-a may include a TCI codepoint that indicates the first TCI state ID and the second TCI state ID (e.g., (TCI ID 1, TCI ID 2)) and the DCI 310-b may include a dynamic codepoint 10. For example, the dynamic codepoint 10 may be used to indicate, to the UE, to use the first TCI state 325 (e.g., corresponding to the first TCI state ID, TCI ID 1) and the second TCI state 326 (e.g., corresponding to the second TCI state ID, TCI ID 2) in accordance with dynamic mTRP operations for one or multiple communication channels, such as PDSCH, PUSCH, or PUCCH, that may be scheduled using the DCI 310-b indicating the dynamic codepoint 10. In such an example, the dynamic codepoint 10 may indicate for the to use the first TCI state 325 prior to the second TCI state 326 in order. Additionally, or alternatively, the dynamic codepoint 11 may indicate for the to use the second TCI state 326 prior to the first TCI state 325 in order.

Although the example of FIG. 3 illustrates dynamic switching between the sTRP operation mode and the mTRP operation mode for PDSCH communications, it is to be understood that a communication channel for which dynamic switching between the sTRP operation mode and the mTRP operation mode is applied may change based on implementation of one or more devices (e.g., the UE, the network entities, or both), and the examples described herein should not be considered limiting to the scope covered by the claims or the disclosure. For example, dynamic switching between the sTRP operation mode and the mTRP operation mode in the unified TCI framework may be configured for (e.g., may be common to) one or more communication channel types. For example, the network may use RRC signaling to configure dynamic switching between the sTRP operation mode and the mTRP operation mode for the PDSCH, a physical downlink control channel (PDCCH), a physical uplink shared channel (PUSCH), or a physical uplink control channel (PUCCH), or any combination thereof. In some examples, the UE may be configured with a channel type list. In some examples, the UE may receive an indication to use an sTRP operation mode or an mTRP operation mode for a channel type included in the channel type list. In such examples, the UE may apply the indicated sTRP or mTRP to other channel types included in the channel type list. For example, if the UE receives a TCI codepoint that indicates for the UE to operate in accordance with the sTRP operation mode or the mTRP operation mode for a channel type included in the configured channel type list, the UE may apply the indicated operation mode (e.g., the sTRP operation mode or the mTRP operation mode) for other communication channels included in the configured channel type list. For example, the PDSCH and PUCCH may be configured in a channel type list. In such an example, if the UE receives an indication (e.g., the DCI 310-a) configuring the PDSCH for mTRP operations, the UE may use the mTRP operation mode for the PDSCH and the PUCCH. Additionally, or alternatively, the PUCCH and the PUSCH may be configured in a channel type list and the PUCCH and the PDSCH may be configured in a channel type list, among other possible examples of communication channels that may be configured in a channel type list. In some examples, dynamic switching between the sTRP operation mode and the mTRP operation mode in the unified TCI framework may be constrained (e.g., dedicated) to one channel type.

Additionally, or alternatively, the UE may be configured with one or more rules for dynamic switching between the sTRP operation mode and the mTRP operation mode in the unified TCI framework for a PUCCH. For example, the UE may receive a TCI indication DCI, such as the DCI 310-a, that indicates two different unified TCI states (e.g., the TCI ID 1 and the TCI ID 2). Additionally, or alternatively, the UE may receive another DCI (e.g., a scheduling DCI) that may include a PUCCH resource indicator scheduling a PUCCH with multiple repetitions. In such an example, the UE may apply the multiple unified TCI states (e.g., the first TCI state 325 and the second TCI state 326) for the PUCCH in accordance with the sTRP operation mode. For example, the UE may map the first TCI state 325 and the second TCI state 326 to multiple (e.g., different) PUCCH repetitions, such that the UE may transmit a first PUCCH repetition using one of the first TCI state 325 and the second TCI state 326 and a second repetition using the other of the first TCI state 325 and the second TCI state 326. In some examples, the UE may map unified TCI states to the PUCCH repetitions in accordance with a mapping pattern (e.g., AABB or ABAB, in which A may correspond to the first TCI state 325 and B may correspond to the second TCI state 326). In such an example, the UE may select the unified TCI state based on the mapping pattern. In some examples, the mapping patter (e.g., an selection of the unified TCI state) may be based on a quantity of unified TCI states indicated to the UE (e.g., using the DCI 310-a) and a quantity of scheduled PUCCH repetitions.

Additionally, or alternatively, the UE may select a unified TCI state for transmission of the PUCCH repetitions in accordance with the sTRP operation mode based on control signaling from the network. For example, the UE may receive RRC signaling from the network that may indicate an RRC configuration to the UE. In such an example, the UE may select the unified TCI state based on the RRC configuration. In some examples, the RRC configuration may be per PUCCH resource. For example, the network may configure the UE to select a unified TCI state for transmission of a PUCCH per PUCCH resource scheduled at the UE.

In some examples, the UE may receive a TCI indication DCI that indicates multiple different unified TCI states and a scheduling DCI that indicates a PUCCH without repetition. For example, the UE may extend the PUCCH to multiple repetitions, in which the repetitions may be based on a quantity of TCI states indicated using the TCI indication DCI. For example, the UE may receive the DCI 310-a that indicates two different TCI states (e.g., the TCI ID 1 and the TCI ID 2) and a scheduling DCI that indicates a PUCCH without repetition. In such examples, the UE may apply the two unified TCI states for the PUCCH in accordance with the sTRP operation mode. For example, the UE may extend the PUCCH to two repetitions and map the two unified TCI states (e.g., the first TCI state 325 and the second TCI state 326) to the two PUCCH repetitions. In such an example, the UE may transmit a first PUCCH repetition using one of the first TCI state 325 and the second TCI state 326 and a second repetition using the other of the first TCI state 325 and the second TCI state 326.

Additionally, or alternatively, the UE may select a unified TCI state for transmission of the PUCCH in accordance with the sTRP operation mode based on control signaling from the network. For example, the UE may receive RRC signaling form the network that may indicate an RRC configuration for the UE. In such an example, the UE may select the unified TCI state based on the RRC configuration. In some examples, the RRC configuration may be per PUCCH resource. For example, the network may configure the UE to select a unified TCI state (e.g., the single indicated unified TCI state, or a unified TCI state corresponding to a relatively first TCI state ID indicated using a TCI codepoint) for transmission of a PUCCH using a PUCCH resource. That is, the UE may select a unified TCI state for each PUCCH resource configured at the UE for transmission of a PUCCH. In some examples, the network may configure the UE to apply multiple unified TCI states for transmission of a PUCCH using a PUCCH resource. That is, the UE may select multiple unified TCI states indicated using a TCI codepoint for each PUCCH resource configured at the UE for transmission of a PUCCH. In some aspects, the UE may receive a PUCCH resource indicator included in a scheduling DCI to indicate a PUCCH resource with an RRC configuration that may match the TCI indication DCI. For example, the UE may receive a PUCCH resource indicator included in a scheduling DCI that indicates a PUCCH resource with an RRC configuration to apply the single unified TCI state if a TCI indication DCI indicates a single unified TCI state. Additionally, or alternatively, the UE may use a PUCCH resource indicator included in a scheduling DCI that indicates a PUCCH resource with an RRC configuration to apply two unified TCI states if a TCI indication DCI indicates two unified TCI states. In some examples, a PUCCH resource may be configured, such that the UE may apply multiple unified TCI states if the PUCCH resource is also configured with multiple repetitions.

In some examples, the TCI indication DCI may indicate single unified TCI state (e.g., the TCI ID 1 or the TCI ID 2), and a PUCCH resource indicator included in a scheduling DCI may indicate a PUCCH with repetition. In such an example, the UE may apply the unified TCI state for the PUCCH. For example, the UE may map the unified TCI state to each (e.g., all) PUCCH repetitions. Additionally, or alternatively, the UE may reduce the PUCCH repetitions into a single repetition and map the unified TCI to the single PUCCH repetition. In some other examples, the TCI indication DCI may indicate single unified TCI state (e.g., the TCI ID 1 or the TCI ID 2) and a PUCCH resource indicator included in a scheduling DCI may indicate a PUCCH without repetition. In such an example, the UE may apply the unified TCI state for the PUCCH in accordance with the one or more rules.

In some examples, the network may reset (e.g., implicitly or explicitly) a TCI state to be applied at the UE for a scheduled PUCCH transmission to a unified TCI state configured at the UE for a scheduled PDSCH. For example, the UE may identify a TCI state to be applied for a scheduled PUCCH transmission based on a unified TCI state used at the UE for (or configured at the UE for) a scheduled PDSCH. In some examples, the UE may use a unified TCI state configured or indicated for a scheduled PDSCH (e.g., using a TCI indication DCI, such as the DCI 310-b) for transmission of a scheduled PUCCH. That is, the UE may update a beam used at the UE for PUCCH transmissions based on beam indicated to the UE to use for a scheduled PDSCH transmission. For example, the UE may apply a unified TCI state indicated to the UE using a TCI indication DCI irrespective of a TCI state indicated to the UE using a PUCCH resource indicator included in the scheduling DCI (e.g., irrespective of the PUCCH resource indicator and corresponding configured TCI states). In some examples, the UE may apply the unified TCI state indicated using the TCI indication DCI if the PUCCH and the PDSCH are associated with a same component carrier. Additionally, or alternatively, the UE may apply the unified TCI state indicated using the TCI indication DCI if the PUCCH and the PDSCH are associated with respective component carriers that may be configured in a same component carrier list. In some other examples, the UE may use a unified TCI state for transmission of a PUCCH based on an RRC configuration that may be configured at the UE per PUCCH resource. That is, a TCI indicator DCI (e.g., a TCI codepoint that indicates a dynamic sTRP operation mode) included in a scheduling DCI for a PDSCH may not impact a scheduled PUCCH. In some examples, selecting a unified TCI state for PUCCH transmissions using one or more rules configured at the UE may lead to improved network operations and network work efficiencies, among other possible benefits.

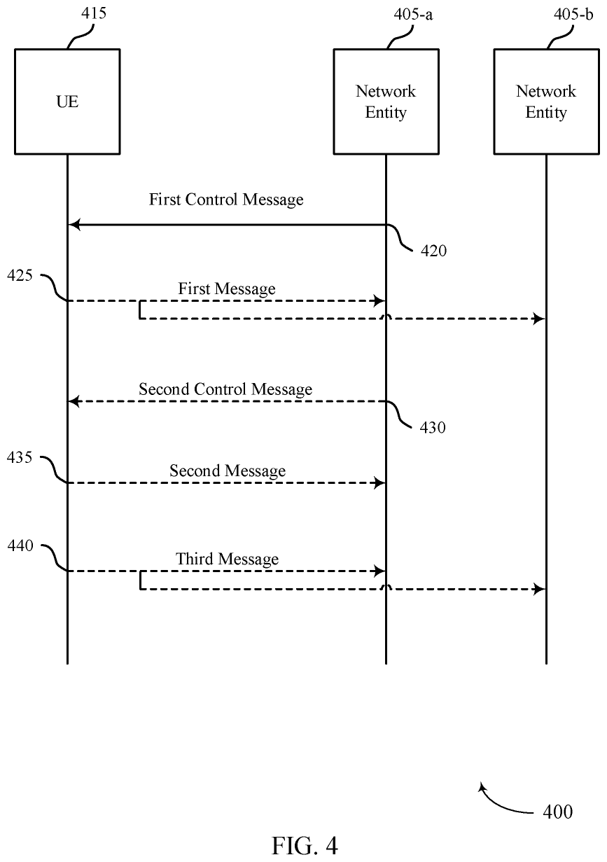

FIG. 4 illustrates an example of a process flow 400 that supports TRP mode switching in accordance with one or more aspects of the present disclosure. In some examples, the process flow 400 may implement or be implemented at one or more aspects of the wireless communications system 100, the wireless communications system 200, and the timing diagram 300. For example, the process flow 400 may include example operations associated with a UE 415, a network entity 405-a, and a network entity 405-b, which may be examples of the corresponding device described with reference to FIGS. 1 through 3. The operations performed at the UE 415, the network entity 405-a, and the network entity 405-b may support improvements to communications between the UE 415 and the network, among other possible benefits. In the following description of the process flow 400, operations between the UE 415, the network entity 405-a, and the network entity 405-b may occur in a different order or at different times than as shown. Some operations may also be omitted from the process flow 400, and other operations may be added to the process flow 400.

At 420, the UE 215 may receive a first control message from the network entity 405-a. In some examples, the first control message may be an example of a control message described throughout the present disclosure including with reference to FIGS. 2 and 3. For example, the first control message may include a first TCI codepoint that indicates multiple unified TCI states for wireless communications at the UE 415 using a communication channel. In some examples, the TCI codepoint may indicate a first unified TCI state associated with the network entity 405-a and a second unified TCI state associated with the network entity 405-b.

In some examples, the UE 415 may communicate (e.g., transmit or receive) a first message using the communication channel in accordance with mTRP operation mode based on the first TCI codepoint indicating multiple unified TCI states. For example, at 425, the UE 415 may concurrently transmit a first message to the network entity 405-a using a first beam corresponding to the first unified TCI state and a first message to the network entity 405-b using a second beam corresponding to the second unified TCI state.

Additionally, or alternatively, at 430, the UE 415 may receive a second control message from the network entity 405-a. The second control message may be an example of a control message described throughout the present disclosure including with reference to FIGS. 2 and 3. For example, the second control message may including a second TCI codepoint that indicates a unified TCI state (e.g., of the multiple unified TCI states indicated using the first control message received at 420). For example, the second control message may indicate the first TCI state associated with the network entity 405-a. Additionally, or alternatively, the second control message may schedules a resource for communicating a second message using the communication channel (or another communication channel). In such an example, based on the second TCI codepoint indicating the first TCI state, the UE 215 may communicate (e.g., transmit or receive) the second message with the network entity 405-a. For example, at 435, the UE 415 may transmit the second message to the network entity 405-a using the resource for communicating the second message and the indicated unified TCI state (e.g., the first TCI state) in accordance with the sTRP operation mode.

In some examples, the UE 415 may switch from the sTRP operation mode to the mTRP operation mode for communications that may occur subsequent to communication of the second message. For example, at 440, the UE 415 may concurrently transmit a third message to the network entity 405-a and the network entity 405-b in accordance with the mTRP operation mode. In some examples, using a TCI codepoint to enable the UE 415 to dynamically switch between the sTRP operation mode and the mTRP operation mode may lead to improved communications between the UE 415 and the network, among other possible benefits.

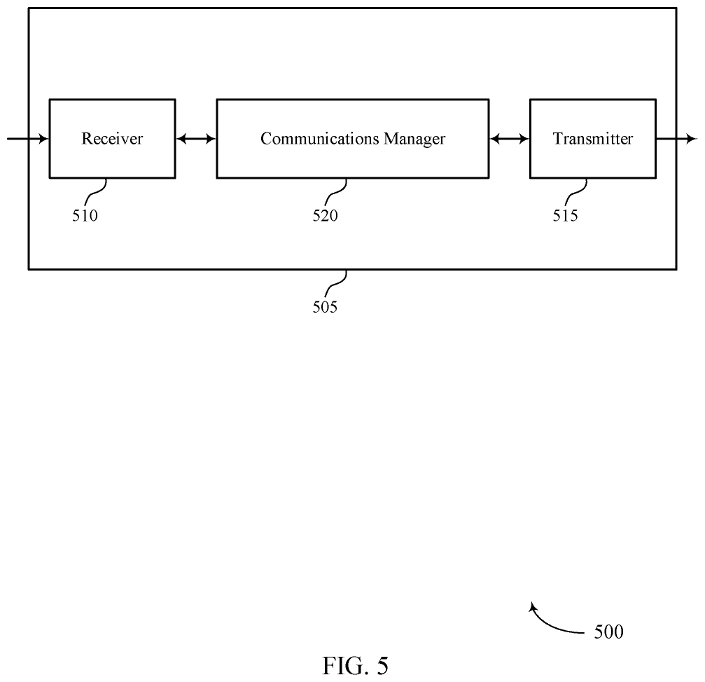

FIG. 5 shows a block diagram 500 of a device 505 that supports TRP mode switching in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to TRP mode switching). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to TRP mode switching). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of TRP mode switching as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE (e.g., the device 505) in accordance with examples as disclosed herein. For example, the communications manager 520 may be configured as or otherwise support a means for receiving a first control message including a first TCI codepoint that indicates a set of multiple unified TCI states for wireless communications at the UE using a communication channel. The communications manager 520 may be configured as or otherwise support a means for communicating a first message using the communication channel in accordance with an mTRP operation mode based on the first TCI codepoint indicating the set of multiple unified TCI states.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources.

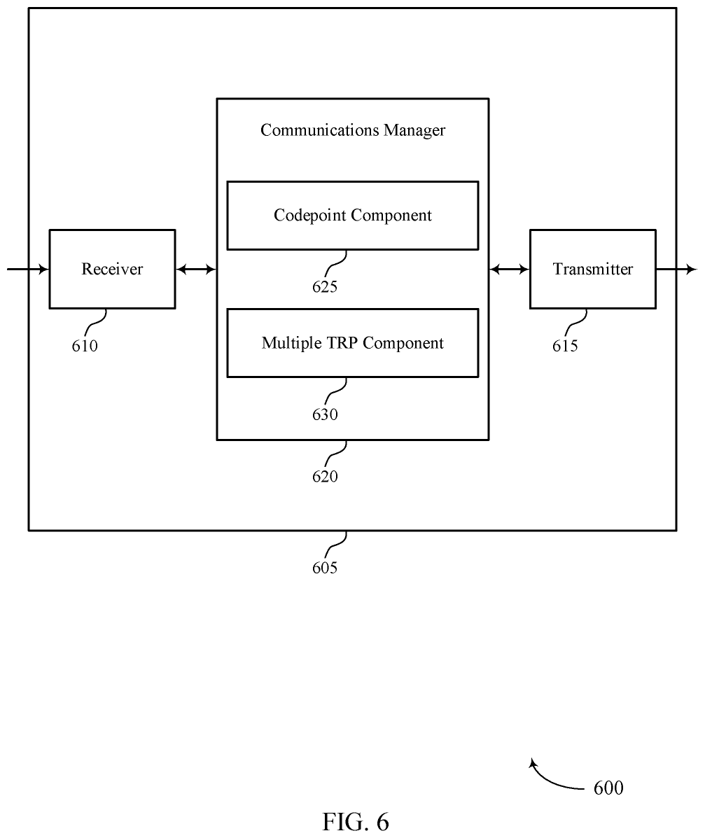

FIG. 6 shows a block diagram 600 of a device 605 that supports TRP mode switching in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to TRP mode switching). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to TRP mode switching). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of TRP mode switching as described herein. For example, the communications manager 620 may include a codepoint component 625 a multiple TRP component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE (e.g., the device 605) in accordance with examples as disclosed herein. The codepoint component 625 may be configured as or otherwise support a means for receiving a first control message including a first TCI codepoint that indicates a set of multiple unified TCI states for wireless communications at the UE using a communication channel. The multiple TRP component 630 may be configured as or otherwise support a means for communicating a first message using the communication channel in accordance with an mTRP operation mode based on the first TCI codepoint indicating the set of multiple unified TCI states.

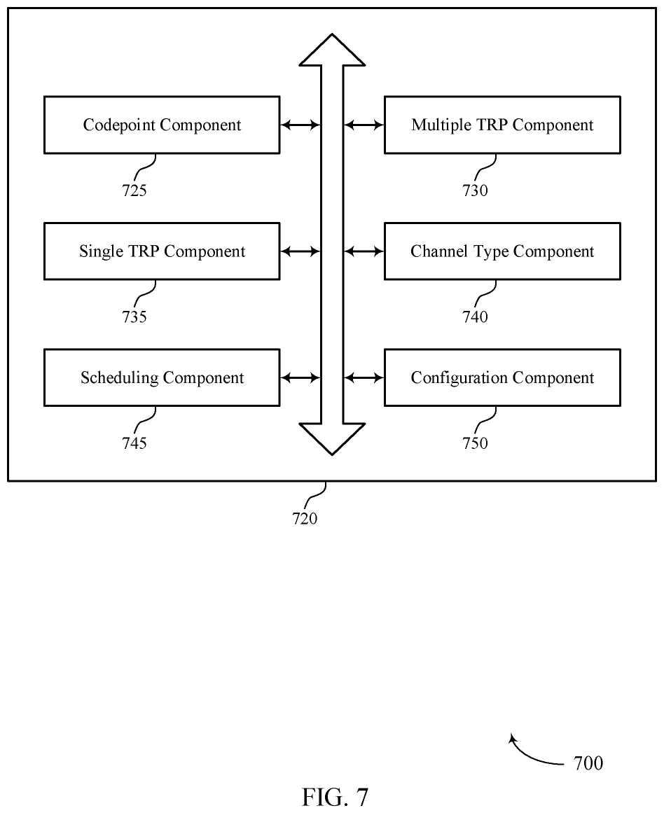

FIG. 7 shows a block diagram 700 of a communications manager 720 that supports TRP mode switching in accordance with one or more aspects of the present disclosure. The communications manager 720 may be an example of aspects of a communications manager 520, a communications manager 620, or both, as described herein. The communications manager 720, or various components thereof, may be an example of means for performing various aspects of TRP mode switching as described herein. For example, the communications manager 720 may include a codepoint component 725, a multiple TRP component 730, a single TRP component 735, a channel type component 740, a scheduling component 745, a configuration component 750, or any combination thereof. Each of these components may communicate, directly or indirectly, with one another (e.g., via one or more buses).

The communications manager 720 may support wireless communication at a UE in accordance with examples as disclosed herein. The codepoint component 725 may be configured as or otherwise support a means for receiving a first control message including a first TCI codepoint that indicates a set of multiple unified TCI states for wireless communications at the UE using a communication channel. The multiple TRP component 730 may be configured as or otherwise support a means for communicating a first message using the communication channel in accordance with an mTRP operation mode based on the first TCI codepoint indicating the set of multiple unified TCI states.

In some examples, the codepoint component 725 may be configured as or otherwise support a means for receiving a second control message including a second TCI codepoint that indicates a unified TCI state of the set of multiple unified TCI states and schedules a resource for communicating a second message using the communication channel. In some examples, the single TRP component 735 may be configured as or otherwise support a means for communicating the second message using the resource for communicating the second message and the unified TCI state in accordance with an sTRP operation mode based on the second TCI codepoint indicating the unified TCI state.

In some examples, the multiple TRP component 730 may be configured as or otherwise support a means for communicating a third message subsequent to the second message, the third message communicated using the communication channel in accordance with the mTRP operation mode.

In some examples, the scheduling component 745 may be configured as or otherwise support a means for receiving a third control message scheduling a resource for communicating a third message using a second communication channel. In some examples, the single TRP component 735 may be configured as or otherwise support a means for communicating the third message using the resource for communicating the third message and the unified TCI state in accordance with the sTRP operation mode based on the communication channel being associated with a same component carrier or a same set of component carriers as the second communication channel.

In some examples, the channel type component 740 may be configured as or otherwise support a means for receiving a second control message indicating a set of associated channel types that includes at least a first channel type associated with the communication channel and a second channel type associated with a second communication channel. In some examples, the multiple TRP component 730 may be configured as or otherwise support a means for communicating a second message using the second communication channel in accordance with the mTRP operation mode based on the first channel type being associated with the second channel type. In some examples, the first channel type includes one of a PDCCH, a PDSCH, a PUCCH, and a PUSCH and the second channel type includes a different one of the PDCCH, the PDSCH, the PUCCH, and the PUSCH in any combination so long as the first channel type and the second channel type are different.

In some examples, the scheduling component 745 may be configured as or otherwise support a means for receiving a second control message scheduling a set of multiple resources for transmission of a second message using a second communication channel. In some examples, the single TRP component 735 may be configured as or otherwise support a means for transmitting the second message using the set of multiple resources and the set of multiple unified TCI states in accordance with an sTRP operation mode and a mapping between the set of multiple resources and the set of multiple unified TCI states.

In some examples, the configuration component 750 may be configured as or otherwise support a means for receiving a second control message indicating a configuration for unified TCI state selection for wireless communications at the UE using a second communication channel. In some examples, the scheduling component 745 may be configured as or otherwise support a means for receiving a third control message scheduling a set of multiple resources for transmission of a second message using the second communication channel. In some examples, the single TRP component 735 may be configured as or otherwise support a means for transmitting the second message using the set of multiple resources and a unified TCI state in accordance with an sTRP operation mode, where the unified TCI state is selected at the UE from the set of multiple unified TCI states in accordance with the configuration.

In some examples, the scheduling component 745 may be configured as or otherwise support a means for receiving a second control message scheduling a first resource for transmission of a second message using a second communication channel. In some examples, the single TRP component 735 may be configured as or otherwise support a means for transmitting the second message using the first resource and a first unified TCI state of the set of multiple unified TCI states in accordance with an sTRP operation mode. In some examples, the single TRP component 735 may be configured as or otherwise support a means for transmitting the second message using a second resource and a second unified TCI state of the set of multiple unified TCI states in accordance with the sTRP operation mode.

In some examples, the configuration component 750 may be configured as or otherwise support a means for receiving a second control message indicating a configuration for unified TCI state selection for wireless communications at the UE using a second communication channel. In some examples, the scheduling component 745 may be configured as or otherwise support a means for receiving a third control message scheduling a resource for transmission of a second message using the second communication channel. In some examples, the single TRP component 735 may be configured as or otherwise support a means for transmitting the second message using the resource for transmission of the second message and a unified TCI state in accordance with an sTRP operation mode, the unified TCI state selected at the UE in accordance with the configuration.

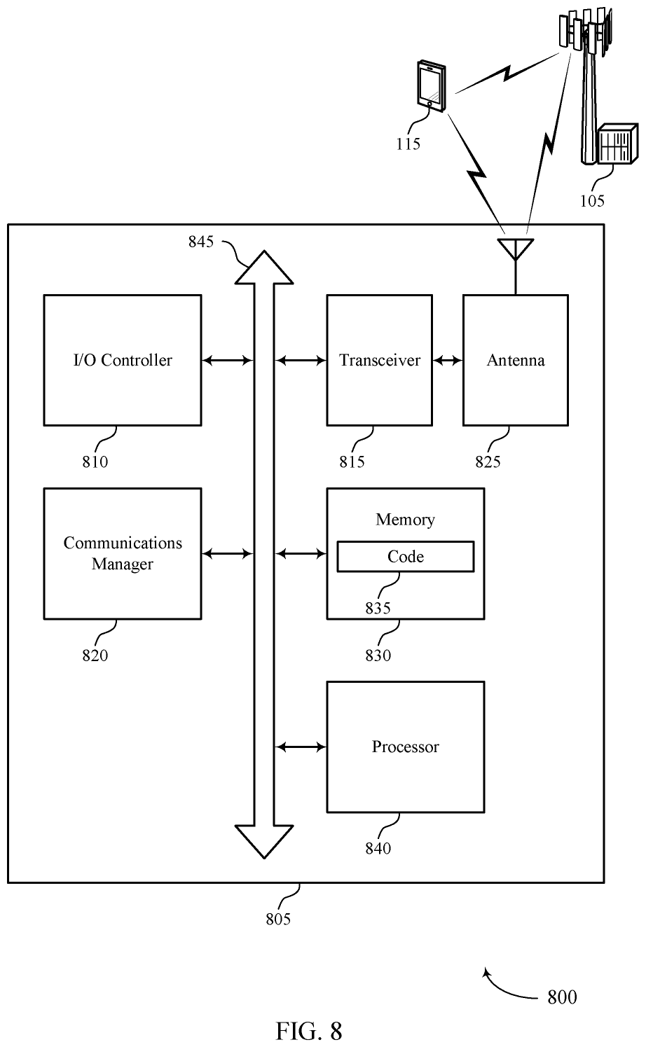

FIG. 8 shows a diagram of a system 800 including a device 805 that supports TRP mode switching in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting TRP mode switching). For example, the device 805 or a component of the device 805 may include a processor 840 and memory 830 coupled with or to the processor 840, the processor 840 and memory 830 configured to perform various functions described herein.

The communications manager 820 may support wireless communication at a UE (e.g., the device 805) in accordance with examples as disclosed herein. For example, the communications manager 820 may be configured as or otherwise support a means for receiving a first control message including a first TCI codepoint that indicates a set of multiple unified TCI states for wireless communications at the UE using a communication channel. The communications manager 820 may be configured as or otherwise support a means for communicating a first message using the communication channel in accordance with an mTRP operation mode based on the first TCI codepoint indicating the set of multiple unified TCI states.

By including or configuring the communications manager 820 in accordance with examples as described herein, the device 805 may support techniques for improved communication reliability, reduced latency, and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. For example, the communications manager 820 may be configured to receive or transmit messages or other signaling as described herein via the transceiver 815. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of TRP mode switching as described herein, or the processor 840 and the memory 830 may be otherwise configured to perform or support such operations.

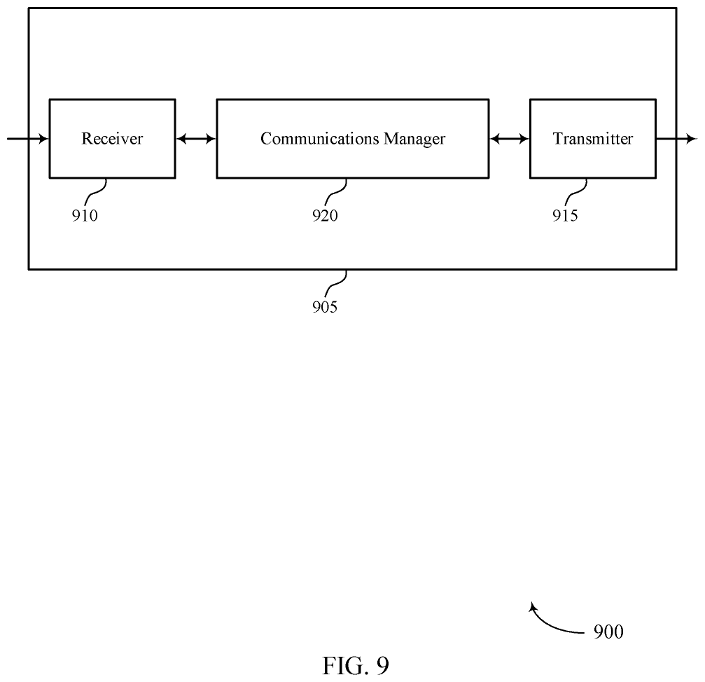

FIG. 9 shows a block diagram 900 of a device 905 that supports TRP mode switching in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of TRP mode switching as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity (e.g., the device 905) in accordance with examples as disclosed herein. For example, the communications manager 920 may be configured as or otherwise support a means for outputting a first control message including a first TCI codepoint that indicates a set of multiple unified TCI states for wireless communications at a UE using a communication channel, the set of multiple unified TCI states indicating, to the UE, to communicate using the communication channel in accordance with an mTRP operation mode. The communications manager 920 may be configured as or otherwise support a means for communicating a first message with the UE using the communication channel based on the network entity being associated with a unified TCI state of the set of multiple unified TCI states.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources.

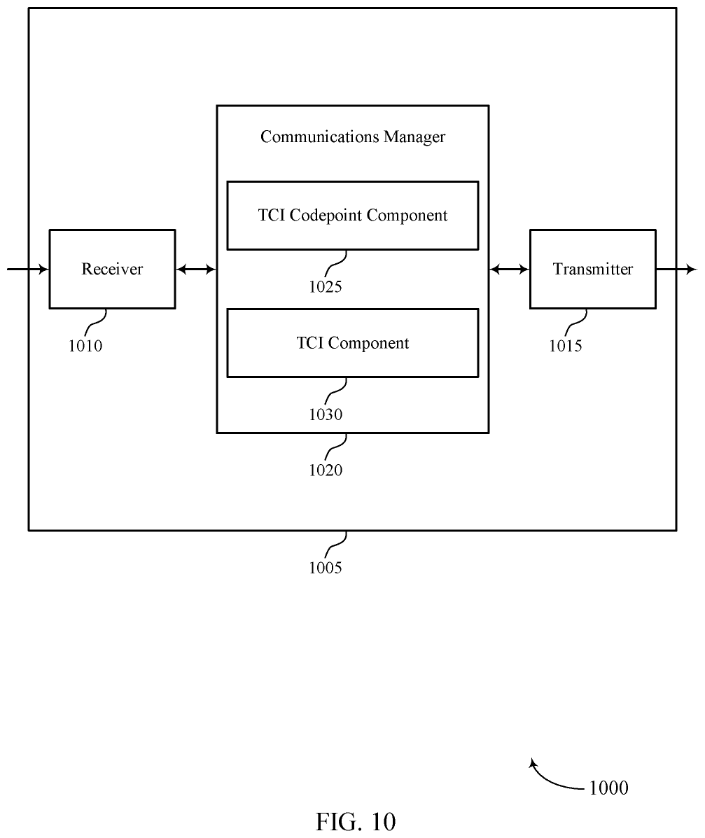

FIG. 10 shows a block diagram 1000 of a device 1005 that supports TRP mode switching in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of TRP mode switching as described herein. For example, the communications manager 1020 may include a TCI codepoint component 1025 a TCI component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity (e.g., the device 1005) in accordance with examples as disclosed herein. The TCI codepoint component 1025 may be configured as or otherwise support a means for outputting a first control message including a first TCI codepoint that indicates a set of multiple unified TCI states for wireless communications at a UE using a communication channel, the set of multiple unified TCI states indicating, to the UE, to communicate using the communication channel in accordance with an mTRP operation mode. The TCI component 1030 may be configured as or otherwise support a means for communicating a first message with the UE using the communication channel based on the network entity being associated with a unified TCI state of the set of multiple unified TCI states.

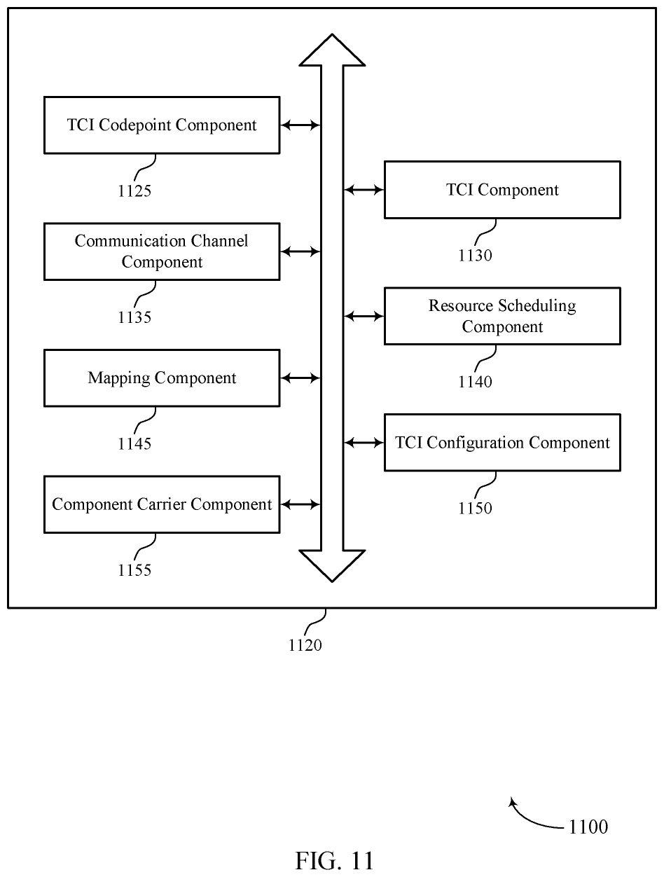

FIG. 11 shows a block diagram 1100 of a communications manager 1120 that supports TRP mode switching in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of TRP mode switching as described herein. For example, the communications manager 1120 may include a TCI codepoint component 1125, a TCI component 1130, a communication channel component 1135, a resource scheduling component 1140, a mapping component 1145, a TCI configuration component 1150, a component carrier component 1155, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The TCI codepoint component 1125 may be configured as or otherwise support a means for outputting a first control message including a first TCI codepoint that indicates a set of multiple unified TCI states for wireless communications at a UE using a communication channel, the set of multiple unified TCI states indicating, to the UE, to communicate using the communication channel in accordance with an mTRP operation mode. The TCI component 1130 may be configured as or otherwise support a means for communicating a first message with the UE using the communication channel based on the network entity being associated with a unified TCI state of the set of multiple unified TCI states.

In some examples, the TCI codepoint component 1125 may be configured as or otherwise support a means for outputting a second control message including a second TCI codepoint that indicates the unified TCI state of the set of multiple unified TCI states and schedules a resource for communicating a second message using the communication channel, the unified TCI state indicating, to the UE, to communicate using the communication channel in accordance with an sTRP operation mode. In some examples, the TCI component 1130 may be configured as or otherwise support a means for communicating the second message using the resource for communicating the second message based on the second TCI codepoint indicating the unified TCI state associated with the network entity.

In some examples, the resource scheduling component 1140 may be configured as or otherwise support a means for outputting a third control message scheduling a resource for communicating a third message using a second communication channel. In some examples, the component carrier component 1155 may be configured as or otherwise support a means for communicating the third message using the resource for communicating the third message based on the communication channel being associated with a same component carrier or a same set of component carriers as the second communication channel.

In some examples, the communication channel component 1135 may be configured as or otherwise support a means for outputting a second control message indicating a set of associated channel types that includes at least a first channel type associated with the communication channel and a second channel type associated with a second communication channel. In some examples, the communication channel component 1135 may be configured as or otherwise support a means for communicating a second message using the second communication channel based on the first channel type being associated with the second channel type. In some examples, the first channel type includes one of a PDCCH, a PDSCH, a PUCCH, and a PUSCH and the second channel type includes a different one of the PDCCH, the PDSCH, the PUCCH, and the PUSCH in any combination so long as the first channel type and the second channel type are different.

In some examples, the resource scheduling component 1140 may be configured as or otherwise support a means for outputting a second control message scheduling, at the UE, a set of multiple resources for communicating a second message using a second communication channel. In some examples, the mapping component 1145 may be configured as or otherwise support a means for obtaining, from the UE, the second message using a resource of the set of multiple resources based on a mapping between the set of multiple resources and the set of multiple unified TCI states.

In some examples, the TCI configuration component 1150 may be configured as or otherwise support a means for outputting a second control message indicating a configuration for unified TCI state selection, at the UE, for wireless communications using a second communication channel. In some examples, the resource scheduling component 1140 may be configured as or otherwise support a means for outputting a third control message scheduling, at the UE, a set of multiple resources for communicating a second message using the second communication channel. In some examples, the TCI component 1130 may be configured as or otherwise support a means for obtaining, from the UE, the second message using the set of multiple resources based on the UE selecting the unified TCI state from the set of multiple unified TCI states in accordance with the configuration.

In some examples, the TCI configuration component 1150 may be configured as or otherwise support a means for outputting a second control message indicating a configuration for unified TCI state selection, at the UE, for wireless communications using a second communication channel. In some examples, the resource scheduling component 1140 may be configured as or otherwise support a means for outputting a third control message scheduling, at the UE, a resource for communicating a second message using the second communication channel. In some examples, the TCI component 1130 may be configured as or otherwise support a means for obtaining, from the UE, the second message using the resource for communicating the second message based on the UE selecting the unified TCI state in accordance with the configuration.

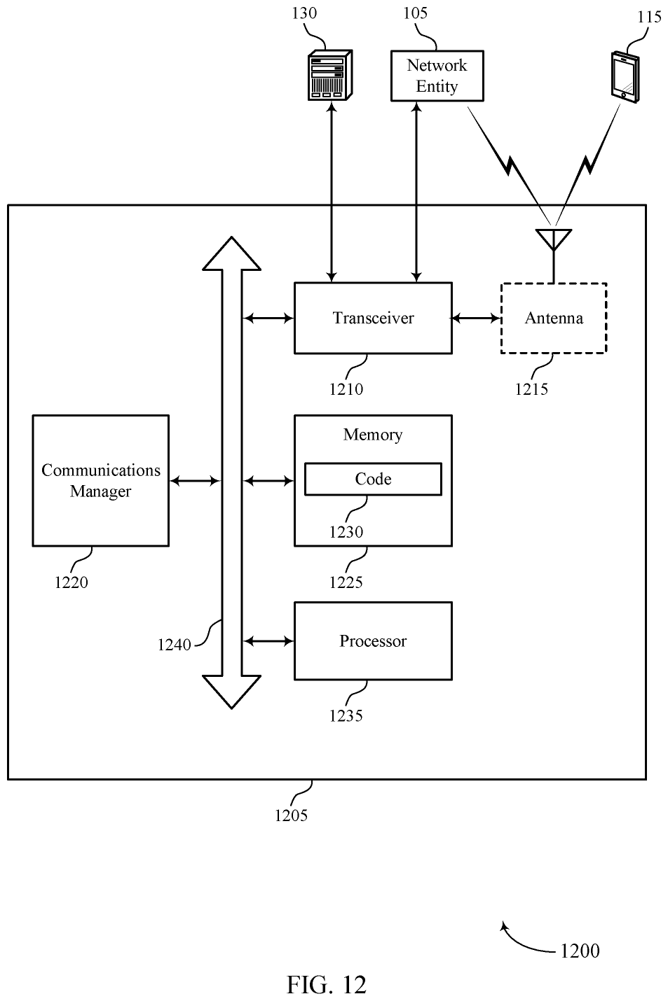

FIG. 12 shows a diagram of a system 1200 including a device 1205 that supports TRP mode switching in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting TRP mode switching). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity (e.g., the device 1205) in accordance with examples as disclosed herein. For example, the communications manager 1220 may be configured as or otherwise support a means for outputting a first control message including a first TCI codepoint that indicates a set of multiple unified TCI states for wireless communications at a UE using a communication channel, the set of multiple unified TCI states indicating, to the UE, to communicate using the communication channel in accordance with an mTRP operation mode. The communications manager 1220 may be configured as or otherwise support a means for communicating a first message with the UE using the communication channel based on the network entity being associated with a unified TCI state of the set of multiple unified TCI states.

By including or configuring the communications manager 1220 in

accordance with examples as described herein, the device 1205 may support techniques for improved communication reliability, reduced latency, and more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. For example, the communications manager 1220 may be configured to receive or transmit messages or other signaling as described herein via the transceiver 1210. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of TRP mode switching as described herein, or the processor 1235 and the memory 1225 may be otherwise configured to perform or support such operations.

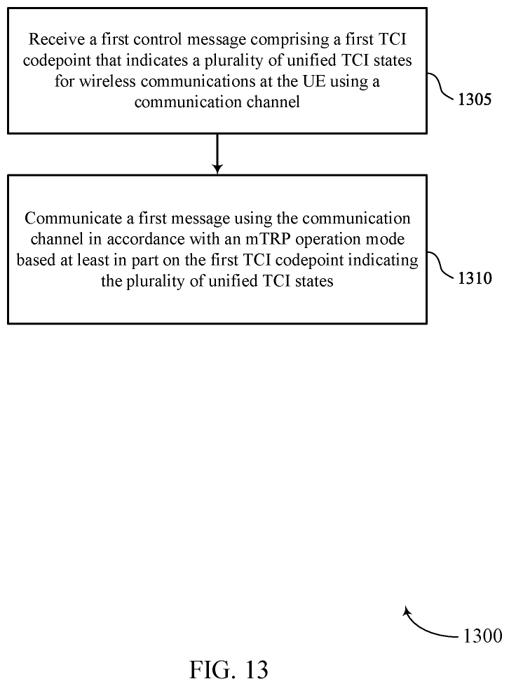

FIG. 13 shows a flowchart illustrating a method 1300 that supports TRP mode switching in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first control message including a first TCI codepoint that indicates a set of multiple unified TCI states for wireless communications at the UE using a communication channel. The operations of 1305 may be performed in accordance with examples as disclosed herein, for example, in accordance with 420 as described with reference to FIG. 4. In some examples, aspects of the operations of 1305 may be performed by a codepoint component 725 as described with reference to FIG. 7. Additionally, or alternatively, means for performing 1305 may, but not necessarily, include, for example, antenna 825, transceiver 815, communications manager 820, memory 830 (including code 835), processor 840 and/or bus 845.

At 1310, the method may include communicating a first message using the communication channel in accordance with an mTRP operation mode based on the first TCI codepoint indicating the set of multiple unified TCI states. The operations of 1310 may be performed in accordance with examples as disclosed herein, for example, in accordance with 425 as described with reference to FIG. 4. In some examples, aspects of the operations of 1310 may be performed by a multiple TRP component 730 as described with reference to FIG. 7. Additionally, or alternatively, means for performing 1310 may, but not necessarily, include, for example, antenna 825, transceiver 815, communications manager 820, memory 830 (including code 835), processor 840 and/or bus 845.

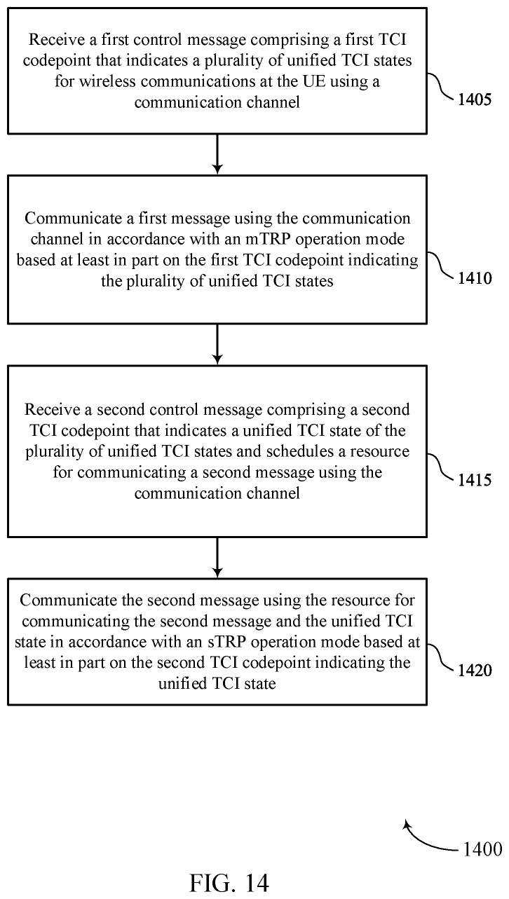

FIG. 14 shows a flowchart illustrating a method 1400 that supports TRP mode switching in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a first control message including a first TCI codepoint that indicates a set of multiple unified TCI states for wireless communications at the UE using a communication channel. The operations of 1405 may be performed in accordance with examples as disclosed herein, for example, in accordance with 420 as described with reference to FIG. 4. In some examples, aspects of the operations of 1405 may be performed by a codepoint component 725 as described with reference to FIG. 7. Additionally, or alternatively, means for performing 1405 may, but not necessarily, include, for example, antenna 825, transceiver 815, communications manager 820, memory 830 (including code 835), processor 840 and/or bus 845

At 1410, the method may include communicating a first message using the communication channel in accordance with an mTRP operation mode based on the first TCI codepoint indicating the set of multiple unified TCI states. The operations of 1410 may be performed in accordance with examples as disclosed herein, for example, in accordance with 425 as described with reference to FIG. 4. In some examples, aspects of the operations of 1410 may be performed by a multiple TRP component 730 as described with reference to FIG. 7. Additionally, or alternatively, means for performing 1410 may, but not necessarily, include, for example, antenna 825, transceiver 815, communications manager 820, memory 830 (including code 835), processor 840 and/or bus 845.

At 1415, the method may include receiving a second control message including a second TCI codepoint that indicates a unified TCI state of the set of multiple unified TCI states and schedules a resource for communicating a second message using the communication channel. The operations of 1415 may be performed in accordance with examples as disclosed herein, for example, in accordance with 430 as described with reference to FIG. 4. In some examples, aspects of the operations of 1415 may be performed by a codepoint component 725 as described with reference to FIG. 7. Additionally, or alternatively, means for performing 1415 may, but not necessarily, include, for example, antenna 825, transceiver 815, communications manager 820, memory 830 (including code 835), processor 840 and/or bus 845.

At 1420, the method may include communicating the second message using the resource for communicating the second message and the unified TCI state in accordance with an sTRP operation mode based on the second TCI codepoint indicating the unified TCI state. The operations of 1420 may be performed in accordance with examples as disclosed herein, for example, in accordance with 435 as described with reference to FIG. 4. In some examples, aspects of the operations of 1420 may be performed by a single TRP component 735 as described with reference to FIG. 7. Additionally, or alternatively, means for performing 1420 may, but not necessarily, include, for example, antenna 825, transceiver 815, communications manager 820, memory 830 (including code 835), processor 840 and/or bus 845.

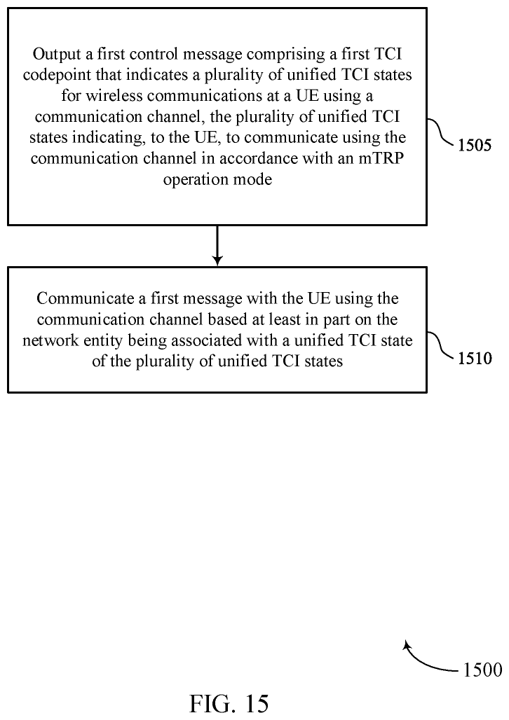

FIG. 15 shows a flowchart illustrating a method 1500 that supports TRP mode switching in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting a first control message including a first TCI codepoint that indicates a set of multiple unified TCI states for wireless communications at a UE using a communication channel, the set of multiple unified TCI states indicating, to the UE, to communicate using the communication channel in accordance with an mTRP operation mode. The operations of 1505 may be performed in accordance with examples as disclosed herein, for example, in accordance with 420 as described with reference to FIG. 4. In some examples, aspects of the operations of 1505 may be performed by a TCI codepoint component 1125 as described with reference to FIG. 11. Additionally, or alternatively, means for performing 1505 may, but not necessarily, include, for example, antenna 1215, transceiver 1210, communications manager 1220, memory 1225 (including code 1230), processor 1235 and/or bus 1240.

At 1510, the method may include communicating a first message with the UE using the communication channel based on the network entity being associated with a unified TCI state of the set of multiple unified TCI states. The operations of 1510 may be performed in accordance with examples as disclosed herein, for example, in accordance with 425 as described with reference to FIG. 4. In some examples, aspects of the operations of 1510 may be performed by a TCI component 1130 as described with reference to FIG. 11. Additionally, or alternatively, means for performing 1510 may, but not necessarily, include, for example, antenna 1215, transceiver 1210, communications manager 1220, memory 1225 (including code 1230), processor 1235 and/or bus 1240.

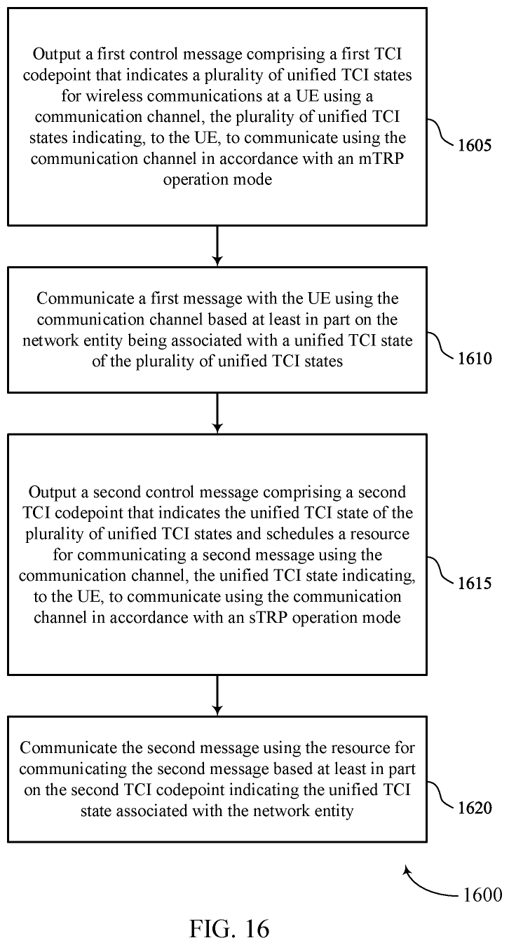

FIG. 16 shows a flowchart illustrating a method 1600 that supports TRP mode switching in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting a first control message including a first TCI codepoint that indicates a set of multiple unified TCI states for wireless communications at a UE using a communication channel, the set of multiple unified TCI states indicating, to the UE, to communicate using the communication channel in accordance with an mTRP operation mode. The operations of 1605 may be performed in accordance with examples as disclosed herein, for example, in accordance with 420 as described with reference to FIG. 4. In some examples, aspects of the operations of 1605 may be performed by a TCI codepoint component 1125 as described with reference to FIG. 11. Additionally, or alternatively, means for performing 1605 may, but not necessarily, include, for example, antenna 1215, transceiver 1210, communications manager 1220, memory 1225 (including code 1230), processor 1235 and/or bus 1240.

At 1610, the method may include communicating a first message with the UE using the communication channel based on the network entity being associated with a unified TCI state of the set of multiple unified TCI states. The operations of 1610 may be performed in accordance with examples as disclosed herein, for example, in accordance with 425 as described with reference to FIG. 4. In some examples, aspects of the operations of 1610 may be performed by a TCI component 1130 as described with reference to FIG. 11. Additionally, or alternatively, means for performing 1610 may, but not necessarily, include, for example, antenna 1215, transceiver 1210, communications manager 1220, memory 1225 (including code 1230), processor 1235 and/or bus 1240.

At 1615, the method may include outputting a second control message including a second TCI codepoint that indicates the unified TCI state of the set of multiple unified TCI states and schedules a resource for communicating a second message using the communication channel, the unified TCI state indicating, to the UE, to communicate using the communication channel in accordance with an sTRP operation mode. The operations of 1615 may be performed in accordance with examples as disclosed herein, for example, in accordance with 430 as described with reference to FIG. 4. In some examples, aspects of the operations of 1615 may be performed by a TCI codepoint component 1125 as described with reference to FIG. 11. Additionally, or alternatively, means for performing 1615 may, but not necessarily, include, for example, antenna 1215, transceiver 1210, communications manager 1220, memory 1225 (including code 1230), processor 1235 and/or bus 1240.

At 1620, the method may include communicating the second message using the resource for communicating the second message based on the second TCI codepoint indicating the unified TCI state associated with the network entity. The operations of 1620 may be performed in accordance with examples as disclosed herein, for example, in accordance with 435 ad described with reference to FIG. 4. In some examples, aspects of the operations of 1620 may be performed by a TCI component 1130 as described with reference to FIG. 11. Additionally, or alternatively, means for performing 1620 may, but not necessarily, include, for example, antenna 1215, transceiver 1210, communications manager 1220, memory 1225 (including code 1230), processor 1235 and/or bus 1240.

The following provides an overview of aspects of the present disclosure:

Aspect 1: A method for wireless communication at a UE, comprising: receiving a first control message comprising a first TCI codepoint that indicates a plurality of unified TCI states for wireless communications at the UE using a communication channel; and communicating a first message using the communication channel in accordance with a mTRP operation mode based at least in part on the first TCI codepoint indicating the plurality of unified TCI states.

Aspect 2: The method of aspect 1, further comprising: receiving a second control message comprising a second TCI codepoint that indicates a unified TCI state of the plurality of unified TCI states and schedules a resource for communicating a second message using the communication channel; and communicating the second message using the resource for communicating the second message and the unified TCI state in accordance with a sTRP operation mode based at least in part on the second TCI codepoint indicating the unified TCI state.

Aspect 3: The method of aspect 2, further comprising: communicating a third message subsequent to the second message, the third message communicated using the communication channel in accordance with the mTRP operation mode.

Aspect 4: The method of aspect 2, further comprising: receiving a third control message scheduling a resource for communicating a third message using a second communication channel; and communicating the third message using the resource for communicating the third message and the unified TCI state in accordance with the sTRP operation mode based at least in part on the communication channel being associated with a same component carrier or a same set of component carriers as the second communication channel.

Aspect 5: The method of any of aspects 1 through 4, further comprising: receiving a second control message indicating a set of associated channel types that includes at least a first channel type associated with the communication channel and a second channel type associated with a second communication channel; and communicating a second message using the second communication channel in accordance with the mTRP operation mode based at least in part on the first channel type being associated with the second channel type.

Aspect 6: The method of aspect 5, wherein the first channel type comprises one of a PDCCH, a PDSCH, a PUCCH, and a PUSCH and the second channel type comprises another of the PDCCH, the PDSCH, the PUCCH, and the PUSCH.

Aspect 7: The method of any of aspects 1 through 6, further comprising: receiving a second control message scheduling a plurality of resources for transmission of a second message using a second communication channel; and transmitting the second message using the plurality of resources and the plurality of unified TCI states in accordance with a sTRP operation mode and a mapping between the plurality of resources and the plurality of unified TCI states.

Aspect 8: The method of any of aspects 1 through 6, further comprising: receiving a second control message indicating a configuration for unified TCI state selection for wireless communications at the UE using a second communication channel; receiving a third control message scheduling a plurality of resources for transmission of a second message using the second communication channel; and transmitting the second message using the plurality of resources and a unified TCI state in accordance with a sTRP operation mode, wherein the unified TCI state is selected at the UE from the plurality of unified TCI states in accordance with the configuration.

Aspect 9: The method of any of aspects 1 through 6, further comprising: receiving a second control message scheduling a first resource for transmission of a second message using a second communication channel; transmitting the second message using the first resource and a first unified TCI state of the plurality of unified TCI states in accordance with a sTRP operation mode; and transmitting the second message using a second resource and a second unified TCI state of the plurality of unified TCI states in accordance with the sTRP operation mode.

Aspect 10: The method of any of aspects 1 through 6, further comprising: receiving a second control message indicating a configuration for unified TCI state selection for wireless communications at the UE using a second communication channel; receiving a third control message scheduling a resource for transmission of a second message using the second communication channel; and transmitting the second message using the resource for transmission of the second message and a unified TCI state in accordance with a sTRP operation mode, the unified TCI state selected at the UE in accordance with the configuration.

Aspect 11: A method for wireless communication at a network entity, comprising: outputting a first control message comprising a first TCI codepoint that indicates a plurality of unified TCI states for wireless communications at a UE using a communication channel, the plurality of unified TCI states indicating, to the UE, to communicate using the communication channel in accordance with a mTRP operation mode; and communicating a first message with the UE using the communication channel based at least in part on the network entity being associated with a unified TCI state of the plurality of unified TCI states.

Aspect 12: The method of aspect 11, further comprising: outputting a second control message comprising a second TCI codepoint that indicates the unified TCI state of the plurality of unified TCI states and schedules a resource for communicating a second message using the communication channel, the unified TCI state indicating, to the UE, to communicate using the communication channel in accordance with a sTRP operation mode; and communicating the second message using the resource for communicating the second message based at least in part on the second TCI codepoint indicating the unified TCI state associated with the network entity.

Aspect 13: The method of aspect 12, further comprising: outputting a third control message scheduling a resource for communicating a third message using a second communication channel; and communicating the third message using the resource for communicating the third message based at least in part on the communication channel being associated with a same component carrier or a same set of component carriers as the second communication channel.

Aspect 14: The method of any of aspects 11 through 13, further comprising: outputting a second control message indicating a set of associated channel types that includes at least a first channel type associated with the communication channel and a second channel type associated with a second communication channel; and communicating a second message using the second communication channel based at least in part on the first channel type being associated with the second channel type.

Aspect 15: The method of aspect 14, wherein the first channel type comprises one of a PDCCH, a PDSCH, a PUCCH, and a PUSCH and the second channel type comprises another of the PDCCH, the PDSCH, the PUCCH, and the PUSCH.

Aspect 16: The method of any of aspects 11 through 15, further comprising: outputting a second control message scheduling, at the UE, a plurality of resources for communicating a second message using a second communication channel; and obtaining, from the UE, the second message using a resource of the plurality of resources based at least in part on a mapping between the plurality of resources and the plurality of unified TCI states.

Aspect 17: The method of any of aspects 11 through 15, further comprising: outputting a second control message indicating a configuration for unified TCI state selection, at the UE, for wireless communications using a second communication channel; outputting a third control message scheduling, at the UE, a plurality of resources for communicating a second message using the second communication channel; and obtaining, from the UE, the second message using the plurality of resources based at least in part on the UE selecting the unified TCI state from the plurality of unified TCI states in accordance with the configuration.

Aspect 18: The method of any of aspects 11 through 15, further comprising: outputting a second control message indicating a configuration for unified TCI state selection, at the UE, for wireless communications using a second communication channel; outputting a third control message scheduling, at the UE, a resource for communicating a second message using the second communication channel; and obtaining, from the UE, the second message using the resource for communicating the second message based at least in part on the UE selecting the unified TCI state in accordance with the configuration.

Aspect 19: An apparatus comprising a memory, transceiver, and at least one processor coupled with the memory and transceiver; the at least one processor configured to perform a method of any of aspects 1 through 10.

Aspect 20: An apparatus for wireless communication at a UE, comprising at least one means for performing a method of any of aspects 1 through 10.

Aspect 21: A non-transitory computer-readable medium storing code for wireless communication at a UE, the code comprising instructions executable by a processor to perform a method of any of aspects 1 through 10.

Aspect 22: An apparatus for wireless communication comprising a memory and at least one processor coupled with the memory, the at least one processor configured to perform a method of any of aspects 11 through 18.

Aspect 23: An apparatus for wireless communication at a network entity, comprising at least one means for performing a method of any of aspects 11 through 18.

Aspect 24: A non-transitory computer-readable medium storing code for wireless communication at a network entity, the code comprising instructions executable by a processor to perform a method of any of aspects 11 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a user equipment (UE), comprising:
receiving a first control message comprising a first transmission configuration indicator codepoint that indicates a plurality of unified transmission configuration indicator states for wireless communications at the UE using a communication channel; and
communicating a first message using the communication channel in accordance with a multiple transmission reception point operation mode based at least in part on the first transmission configuration indicator codepoint indicating the plurality of unified transmission configuration indicator states.

2. The method of claim 1, further comprising:
receiving a second control message comprising a second transmission configuration indicator codepoint that indicates a unified transmission configuration indicator state of the plurality of unified transmission configuration indicator states and schedules a resource for communicating a second message using the communication channel; and
communicating the second message using the resource for communicating the second message and the unified transmission configuration indicator state in accordance with a single transmission reception point operation mode based at least in part on the second transmission configuration indicator codepoint indicating the unified transmission configuration indicator state.

3. The method of claim 2, further comprising:
communicating a third message subsequent to the second message, the third message communicated using the communication channel in accordance with the multiple transmission reception point operation mode.

4. The method of claim 2, further comprising:
receiving a third control message scheduling a resource for communicating a third message using a second communication channel; and
communicating the third message using the resource for communicating the third message and the unified transmission configuration indicator state in accordance with the single transmission reception point operation mode based at least in part on the communication channel being associated with a same component carrier or a same set of component carriers as the second communication channel.

5. The method of claim 1, further comprising:
receiving a second control message indicating a set of associated channel types that includes at least a first channel type associated with the communication channel and a second channel type associated with a second communication channel; and
communicating a second message using the second communication channel in accordance with the multiple transmission reception point operation mode based at least in part on the first channel type being associated with the second channel type, wherein
the first channel type comprises one of a physical downlink control channel, a physical downlink shared channel, a physical uplink control channel, and a physical uplink shared channel and the second channel type comprises another of the physical downlink control channel, the physical downlink shared channel, the physical uplink control channel, and the physical uplink shared channel.

6. (canceled)

7. The method of claim 1, further comprising:
receiving a second control message scheduling a plurality of resources for transmission of a second message using a second communication channel; and
transmitting the second message using the plurality of resources and the plurality of unified transmission configuration indicator states in accordance with a single transmission reception point operation mode and a mapping between the plurality of resources and the plurality of unified transmission configuration indicator states.

8. The method of claim 1, further comprising:
receiving a second control message indicating a configuration for unified transmission configuration indicator state selection for wireless communications at the UE using a second communication channel, receiving a third control message scheduling a plurality of resources for transmission of a second message using the second communication channel; and
transmitting the second message using the plurality of resources and a unified transmission configuration indicator state in accordance with a single transmission reception point operation mode, wherein the unified transmission configuration indicator state is selected at the UE from the plurality of unified transmission configuration indicator states in accordance with the configuration.

9. The method of claim 1, further comprising:
receiving a second control message scheduling a first resource for transmission of a second message using a second communication channel;
transmitting the second message using the first resource and a first unified transmission configuration indicator state of the plurality of unified transmission configuration indicator states in accordance with a single transmission reception point operation mode; and
transmitting the second message using a second resource and a second unified transmission configuration indicator state of the plurality of unified transmission configuration indicator states in accordance with the single transmission reception point operation mode.

10. The method of claim 1, further comprising:
receiving a second control message indicating a configuration for unified transmission configuration indicator state selection for wireless communications at the UE using a second communication channel;
receiving a third control message scheduling a resource for transmission of a second message using the second communication channel; and
transmitting the second message using the resource for transmission of the second message and a unified transmission configuration indicator state in accordance with a single transmission reception point operation mode, the unified transmission configuration indicator state selected at the UE in accordance with the configuration.

11. A method for wireless communication at a network entity, comprising:
outputting a first control message comprising a first transmission configuration indicator codepoint that indicates a plurality of unified transmission configuration indicator states for wireless communications at a user equipment (UE) using a communication channel, the plurality of unified transmission configuration indicator states indicating, to the UE, to communicate using the communication channel in accordance with a multiple transmission reception point operation mode; and
communicating a first message with the UE using the communication channel based at least in part on the network entity being associated with a unified transmission configuration indicator state of the plurality of unified transmission configuration indicator states.

12. The method of claim 11, further comprising:
outputting a second control message comprising a second transmission configuration indicator codepoint that indicates the unified transmission configuration indicator state of the plurality of unified transmission configuration indicator states and schedules a resource for communicating a second message using the communication channel, the unified transmission configuration indicator state indicating, to the UE, to communicate using the communication channel in accordance with a single transmission reception point operation mode;
communicating the second message using the resource for communicating the second message based at least in part on the second transmission configuration indicator codepoint indicating the unified transmission configuration indicator state associated with the network entity:
outputting a third control message scheduling a resource for communicating a third message using a second communication channel; and
communicating the third message using the resource for communicating the third message based at least in part on the communication channel being associated with a same component carrier or a same set of component carriers as the second communication channel.

13. (canceled)

14. The method of claim 11, further comprising:
outputting a second control message indicating a set of associated channel types that includes at least a first channel type associated with the communication channel and a second channel type associated with a second communication channel; and
communicating a second message using the second communication channel based at least in part on the first channel type being associated with the second channel type, wherein
the first channel type comprises one of a physical downlink control channel, a physical downlink shared channel, a physical uplink control channel, and a physical uplink shared channel and the second channel type comprises another of the physical downlink control channel, the physical downlink shared channel, the physical uplink control channel, and the physical uplink shared channel.

15. (canceled)

16. The method of claim 11, further comprising:
outputting a second control message scheduling, at the UE, a plurality of resources for communicating a second message using a second communication channel; and
obtaining, from the UE, the second message using a resource of the plurality of resources based at least in part on a mapping between the plurality of resources and the plurality of unified transmission configuration indicator states.

17. (canceled)

18. The method of claim 11, further comprising:
outputting a second control message indicating a configuration for unified transmission configuration indicator state selection, at the UE, for wireless communications using a second communication channel;
outputting a third control message scheduling, at the UE, one or more resources for communicating a second message using the second communication channel; and
obtaining, from the UE, the second message using the resource for communicating the second message based at least in part on the UE selecting the unified transmission configuration indicator state from the plurality of unified transmission configuration indicator states in accordance with the configuration.

19. An apparatus for wireless communication, comprising:
memory;
a transceiver; and
at least one processor of a user equipment (UE), the at least one processor coupled with the memory and the transceiver, and the at least one processor configured to:
receive, via the transceiver, a first control message comprising a first transmission configuration indicator codepoint that indicates a plurality of unified transmission configuration indicator states for wireless communications at the UE using a communication channel; and
communicate, via the transceiver, a first message using the communication channel in accordance with a multiple transmission reception point operation mode based at least in part on the first transmission configuration indicator codepoint indicating the plurality of unified transmission configuration indicator states.

20. The apparatus of claim 19, the at least one processor further configured to:
receive, via the transceiver, a second control message comprising a second transmission configuration indicator codepoint that indicates a unified transmission configuration indicator state of the plurality of unified transmission configuration indicator states and schedules a resource for communicating a second message using the communication channel; and
communicate the second message using the resource for communicating the second message and the unified transmission configuration indicator state in accordance with a single transmission reception point operation mode based at least in part on the second transmission configuration indicator codepoint indicating the unified transmission configuration indicator state.

21. The apparatus of claim 20, the at least one processor further configured to:
communicate, via the transceiver, a third message subsequent to the second message, the third message communicated using the communication channel in accordance with the multiple transmission reception point operation mode.

22. The apparatus of claim 20, the at least one processor further configured to:
receive, via the transceiver, a third control message scheduling a resource for communicating a third message using a second communication channel; and
communicate, via the transceiver, the third message using the resource for communicating the third message and the unified transmission configuration indicator state in accordance with the single transmission reception point operation mode based at least in part on the communication channel being associated with a same component carrier or a same set of component carriers as the second communication channel.

23. The apparatus of claim 19, the at least one processor further configured to:
receive, via the transceiver, a second control message indicating a set of associated channel types that includes at least a first channel type associated with the communication channel and a second channel type associated with a second communication channel; and
communicate, via the transceiver, a second message using the second communication channel in accordance with the multiple transmission reception point operation mode based at least in part on the first channel type being associated with the second channel type.

24. The apparatus of claim 19, the at least one processor further configured to:
receive, via the transceiver, a second control message scheduling a plurality of resources for transmission of a second message using a second communication channel; and
transmit, via the transceiver, the second message using the plurality of resources and the plurality of unified transmission configuration indicator states in accordance with a single transmission reception point operation mode and a mapping between the plurality of resources and the plurality of unified transmission configuration indicator states.

25-30. (canceled)
